(19) United States
(12) Patent Application Publication
(10) Pub. No.: US 2001/0034734 A1
(43) Pub. Date: Oct. 25, 2001

(54) Multimedia sports recruiting portal

(76) Inventors: Craig A. Whitley, Newport Beach, CA (US); Michael Piel, Newport Beach, CA (US)

Correspondence Address: Glenn R. Smith, LAW OFFICE OF GLENN R. SMITH, 311 Santa Barbara, Irvine, CA, 92606-0807, US

(21) Appl. No.: 09/780,980

(22) Filed: Feb. 9, 2001

Related U.S. Application Data
(60) Provisional application No. 60/182,744, filed on Feb. 16, 2000.

(51) Int. Cl. G06F 17/30

(52) U.S. Cl. 707/104.1; 707/3; 707/10

(57) ABSTRACT

An computer network portal is a central information source for college and professional sports recruiting coordinators, scouts and coaches to analyze and critique prospective athletes. The portal provides an on-line text and video database regarding high school, collegiate and professional athletes. For any particular athlete, the text database includes game statistics; tangible attributes such as height, weight, speed and strength; intangible attributes such as work ethic, off-season training habits and leadership indicia; and academic records such as grades, entrance exam scores and eligibility. The video database includes clips of sporting event participation and tested performance. User access is through remote client browsers connected to the portal via the Internet. The portal's web server presents a connected browser with a graphical user interface allowing the user to search, select and screen the entire pool of athletes in a particular sport, based on customized and flexible criteria. In response to user inputs, the portal's database server searches the text database and downloads the requested information. Associated video information is accessed by the portal's media server, which downloads encoded video in a streaming format. Athlete data can be directly uploaded to the portal's text database from remote clients. Video tapes of athletic events and tests are typically sent to a central facility, which digitizes and encodes the tapes. This facility then uploads the encoded video to the portal's video library storage array.

### This application claims the benefit of provisional patent application 60/182,744 entitled Multimedia Sports Recruiting Portal, filed Feb. 16, 2000.

### BACKGROUND OF THE INVENTION

College and professional athletics is a highly competitive business capable of generating staggering revenues and requiring tremendous outlays in time and capital. Accordingly, there is increasing pressure for collegiate sport departments and professional sport franchises to assemble the strongest teams with an efficient use of resources. Hence, a critical aspect of the sports business is the process of researching and recruiting capable athletes. In football, for example, each college typically recruits 25 players per season. To arrive at this decision requires coaches and athletic directors to research perhaps 250 to 500 players throughout the country. Coaches and athletic directors often make multiple cross-country trips for many of the final candidates. Professional teams spend millions of dollars scouting and recruiting talent for their teams. Each decision has significant monetary consequences. To make a right decision, these scouts not only need a broader net to make sure they look at all suitable candidates, but they also need a lot more details compared to college recruiting. Hence, a typical sports franchise has to spend a significant amount of time and money researching numerous possible acquisitions to be made in an upcoming draft.

### SUMMARY OF THE INVENTION

From the perspective of both the recruiter and the athlete, the current sports recruiting procedures suffer from several limitations. The required recruiting trips necessarily place a geographical limitation on the entire process, restricting the pool of prospective athletes for particular teams and the choice of colleges for many high-school athletes. There is also a hierarchical limitation, smaller colleges with limited budgets and personnel are limited in the breadth of their search, and athletes from lesser known schools receive limited exposure to the recruiters.

Further the decision process is labor intensive, which is not compatible with time limitations imposed by rule. Recruiters for collegiate athletic programs must work within a limited time frame determined by NCAA rules. Professional sports franchises must make million dollar decisions every year at draft time, often after multiple trades have transacted, forcing the coaching staff and recruiting coordinators to make split-second decisions regarding a particular draft pick.

The multimedia sports recruiting portal according to the present invention alters the way recruiters and coaches of sports teams can view, critique and evaluate athletes. Subscribers to the portal will be able to research and evaluate prospective athletes. Subscribers will have the ability to view an athlete's pertinent statistics, biography, academic standing as well as, tangible and intangible attributes. Using media streaming, subscribers will also be able to view associated video segments highlighting the athlete's participation in high school or college sports events. The multimedia sports portal is also applicable to the transmission, storage and efficient access of sports videos by the many different regulatory agencies involved in the governing of respective athletics.

The high-level benefits of the portal are several. All student-athletes have the opportunity to receive the highest possible exposure. Collegiate and professional recruiting coordinators have the ability to efficiently narrow their prospective scholarship and draft candidates. Recruiters are able to locate players that best fit the mold of their team concept. Colleges have the ability to extend and reach out across boundaries that have typically kept them from recruiting outside their geographical area. Smaller colleges have the capability of recruiting the “second-tier” level athletes in order to enhance their particular athletic programs. Coaches are able to view at their convenience videos on demand, saving travel costs and time. Because the portal allows a flexible search across the entire pool of players, coaches an able to run queries and locate talent that they may have otherwise overlooked due to a lack of information. The portal also allows faster and cheaper distribution of collegiate game videos to teams, conferences and the NCAA in order to meet regulatory restrictions and requirements.

One aspect of the multimedia sports recruiting portal according to the present invention is a sports recruiting method allowing a subscriber to research and evaluate prospective athletes in order to recruit talent for a sports team. The method comprises the steps of compiling an athlete database containing the biographies, statistics and attributes of a plurality of athletes and compiling a sports video database containing a plurality of video clips each featuring the athletes. Further steps are obtaining search criteria from the subscriber and retrieving a portion of the athlete database and a portion of the sports video database regarding at least one of the athletes based upon the criteria. Other steps are displaying fo the subscriber the athlete database portion and playing for the subscriber the sports video database portion.

Another aspect of the present invention is a multimedia sports recruiting portal comprising a remote browser and a central server in communications with the browser An athlete database having text data relating to a plurality of athletes is accessible by the server. A sports video database having multimedia clips relating to at least a portion of the athletes is also accessible by the server. The athlete database and the sports video database are linked. A graphical user interface (GUI) is downloaded from the server to the browser and displayed to a subscriber. The GUI prompts the subscriber for information used to query the athlete database.

A further aspect of the present invention is a multimedia sports recruiting portal comprising a text database means for organizing and storing a plurality of records regarding athletes and a video database means for organizing and storing a plurality of video clips featuring athletes in sporting events and performance tests. A server means accesses the text database means and the video database means and communicates with a remote client over a computer network. A graphical user interface (GUI) means organizes and displays selected portions of the records and the video clips at the client. In one embodiment, the multimedia sports recruiting portal further comprises an encoding center means for receiving, editing and uploading to the server means various video recordings.

### BRIEF DESCRIPTION OF THE DRAWINGS

FIG. 1 is top-level block diagram of a multimedia sports recruiting portal according to the present invention;

FIG. 2 is a top-level information flow diagram for a multimedia sports recruiting portal;

FIGS. 3A-D illustrate various athlete search modes;

FIG. 3A is a detailed information flow diagram for a Player Search request;

FIG. 3B is a detailed information flow diagram for a Position Search request;

FIG. 3C is a detailed information flow diagram for a Regional Search request;

FIG. 3D is a detailed information flow diagram for a Player Profiler request;

FIG. 3E is a detailed information flow diagram for a Player Bookmark request;

FIG. 4 is a block diagram depicting the video capture process;

FIG. 5 is a block diagram of a video encoding facility;

FIG. 6 is a hierarchical diagram illustrating multimedia storage requirements for the portal;

FIG. 7 is a hierarchical diagram illustrating multimedia bandwidth requirements for the portal;

FIG. 8 is a block diagram depicting portal hardware topology;

FIG. 9 is a block diagram depicting portal software topology;

FIGS. 10A-R are browser graphical user interfaces (GUIs);

FIG. 10A is a home page;

FIG. 10B is a login page;

FIG. 10C is a search mode selection page;

FIGS. 10D-J illustrate various search modes;

FIG. 10D is player search page;

FIG. 10E is a search result page;

FIG. 10F is a position search page;

FIG. 10G is a regional search page;

FIG. 10H is a player profiler page;

FIG. 10I is a position details page;

FIG. 10J is a bookmark page;

FIGS. 10K-10P illustrate various attribute pages for a particular athlete;

FIG. 10K is a physical attributes page;

FIG. 10L is a statistics page;

FIG. 10M is a personal attributes page;

FIG. 10N is a coach's comments page;

FIG. 10O is a game videos page;

FIG. 10P is an academics page;

FIG. 10Q is a streaming video player display; and

FIG. 10R is a team roster display.

DETAILED DESCRIPTION OF THE PREFERRED EMBODIMENTS

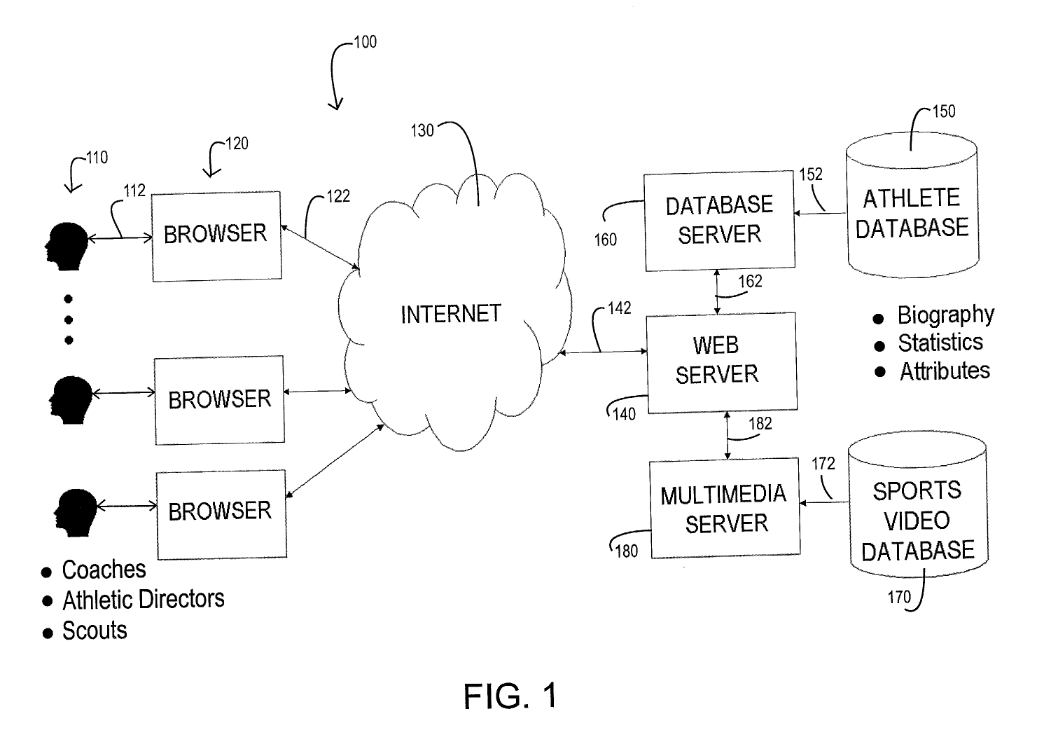

FIG. 1 illustrates one embodiment of a sports recruiting portal 100 according to the present invention. Multiple subscribers 110 utilizing remote browsers 120 communicate over the Internet 130 with a central web server 140. The web server 140 has access to an athlete database 150 via a database server 160. The web server 140 also has access to a sport video database 170 via a multimedia server 180. The athlete database 150 contains biographical and statistical information regarding various athletes and their sports performance in addition to both tangible and intangible attributes associated with each athlete. For example, the biographical information might include an athlete's name, address, birthdate, school, sport, position and coach's name. The statistical information, say for a football quarterback, might include passing attempts, pass completions and interceptions. The tangible attributes might include body composition, such as height, weight and body fat and performance on physical tests of speed and strength. The intangible attributes might include indicia of intelligence, leadership, work ethic and workout habits. The multimedia database 170 contains video segments of various sporting events each featuring a particular athlete listed in the athlete database 150.

As depicted in FIG. 1, the browsers 120 are application programs that allow the subscribers 110 to download and view World Wide Web (web) pages on their computers, as is well-known in the art. The web pages contain code, such as HTML (Hypertext Markup Language), which the browsers 120 interpret and display as graphics and text on a monitor of a subscriber 110. Popular browsers in current use include Netscape® Communicator and Microsoft® Internet Explorer.

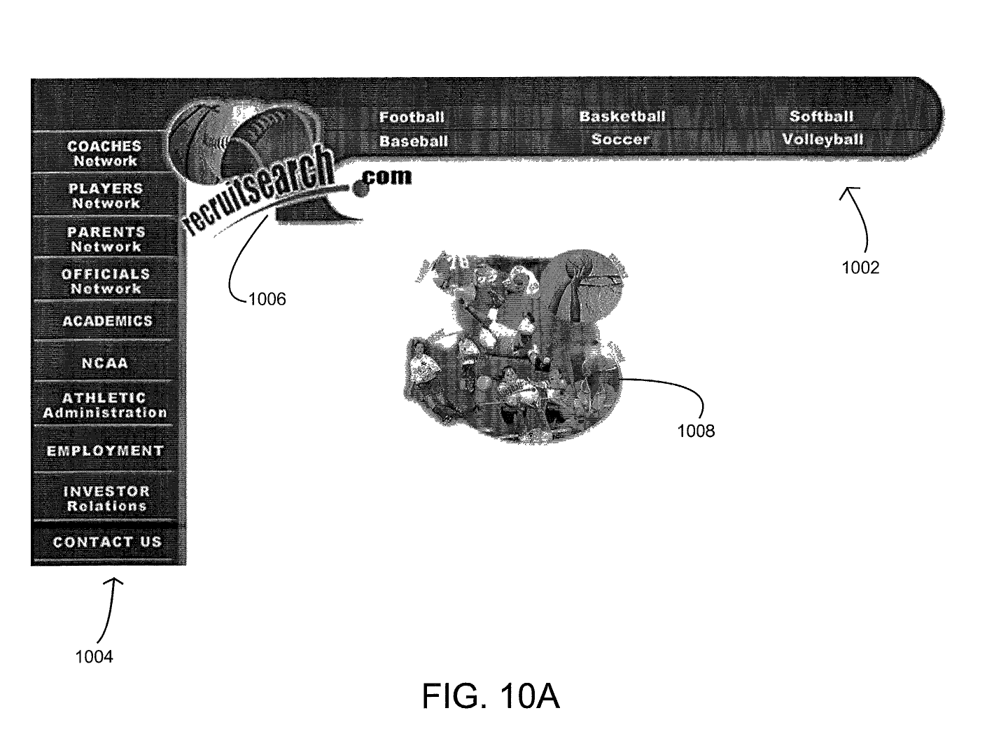

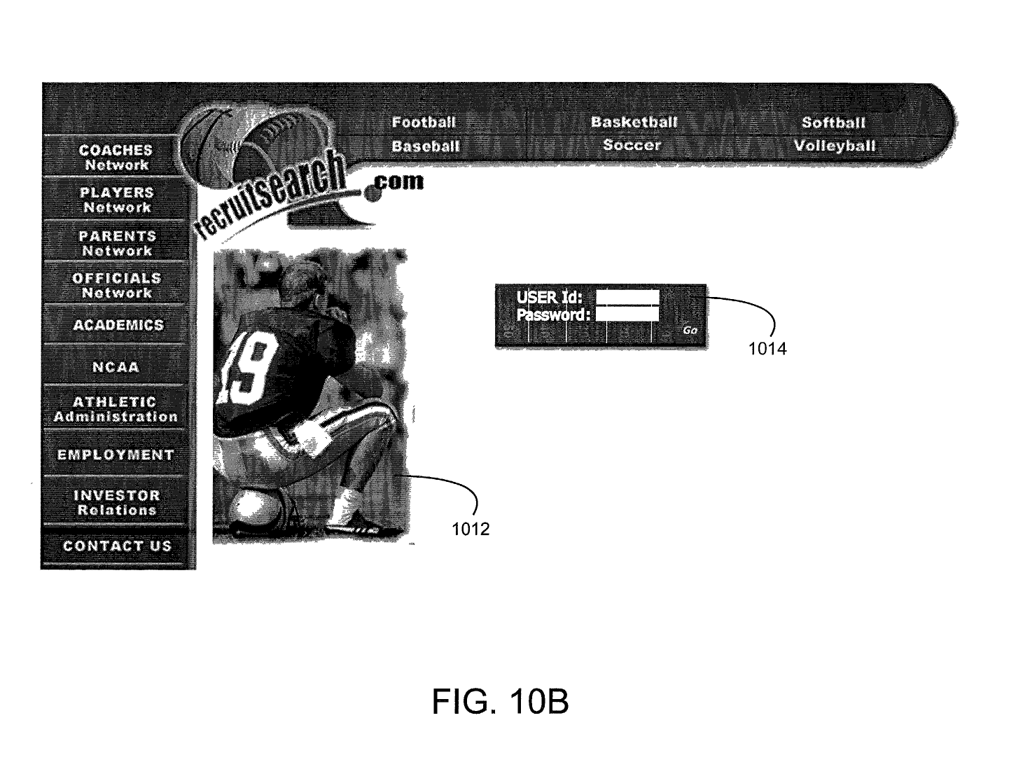

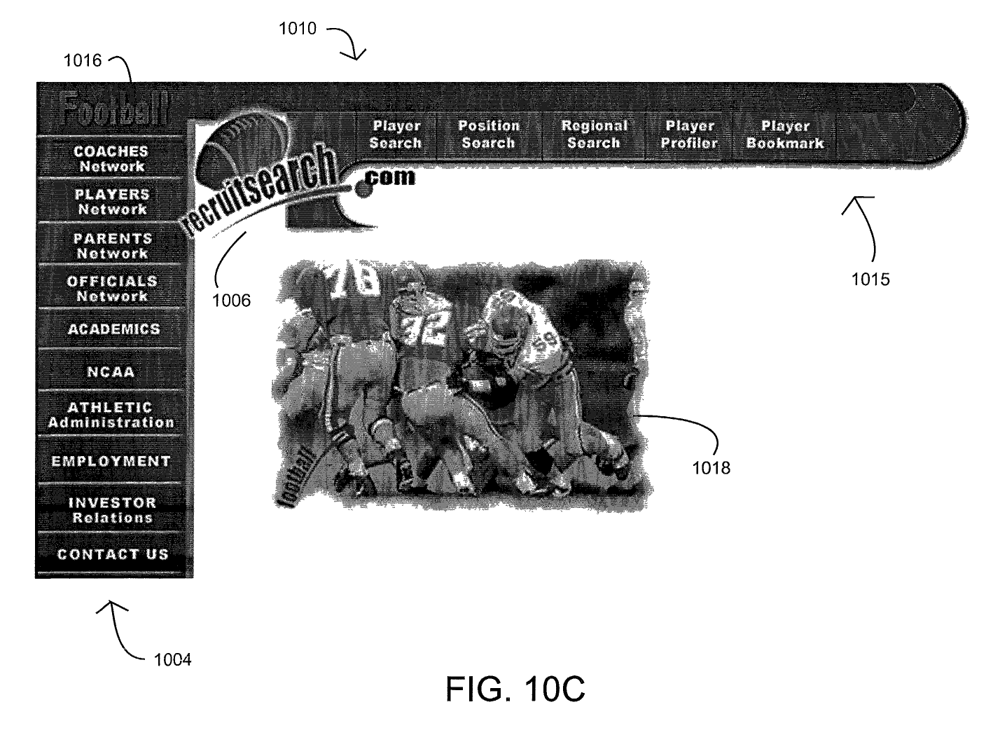

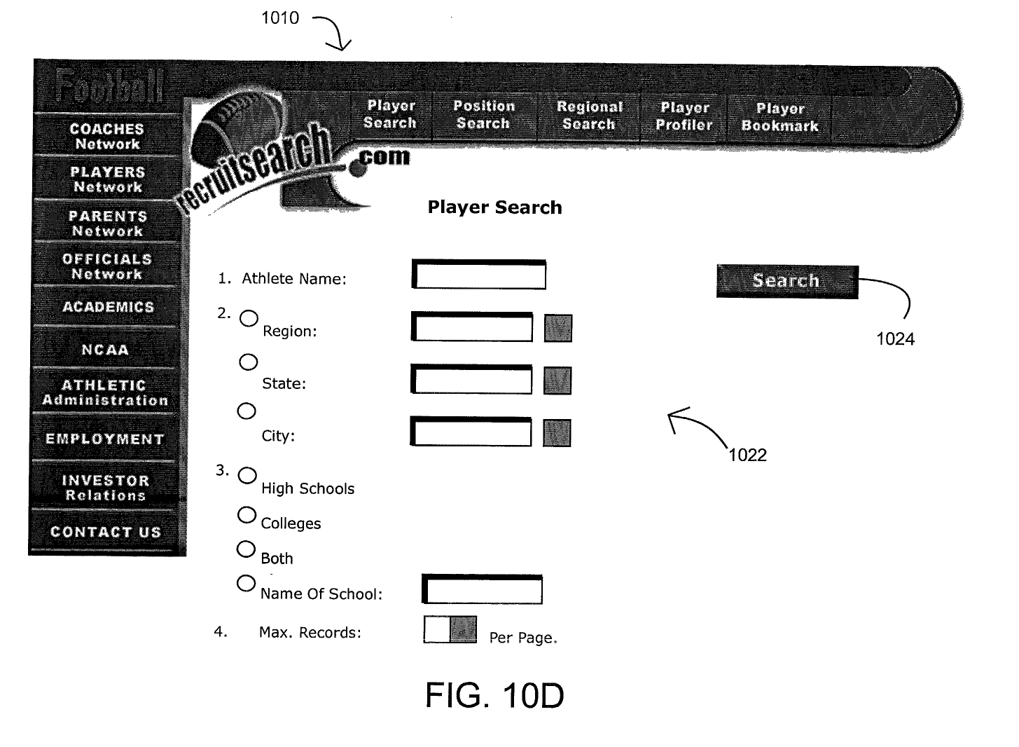

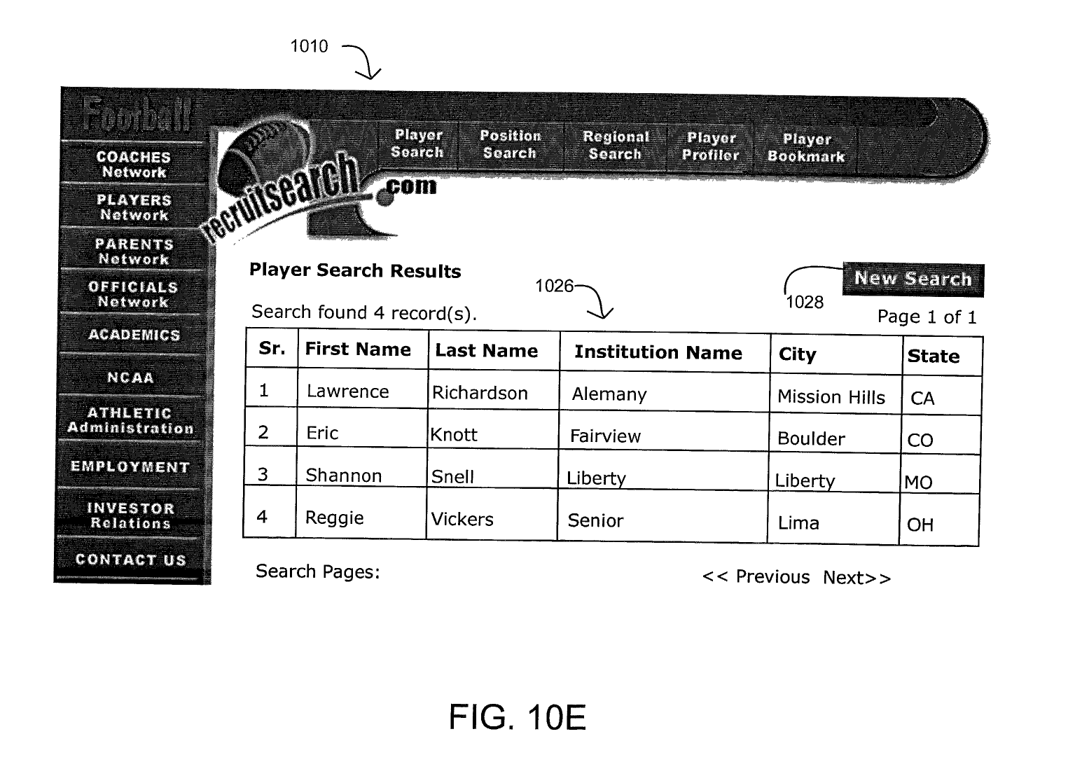

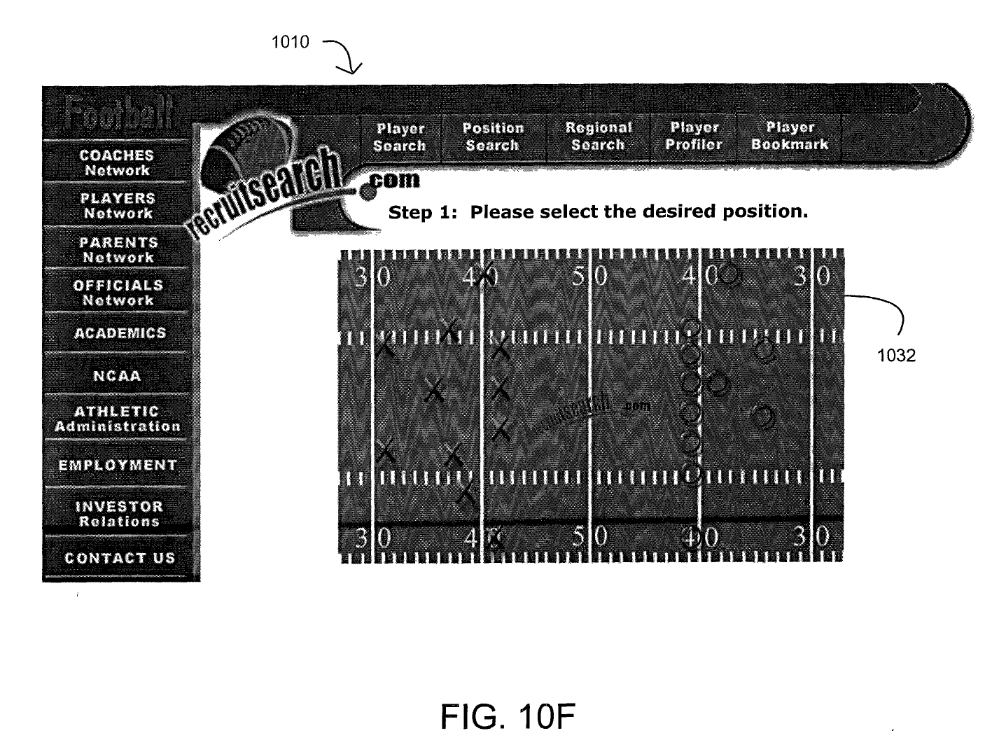

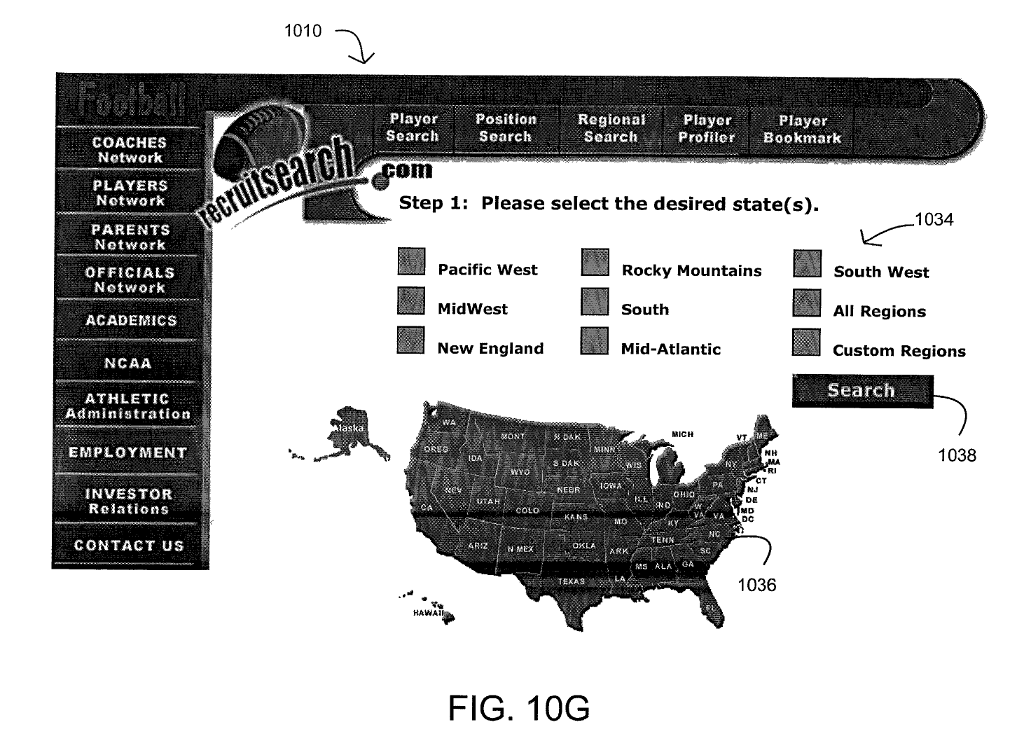

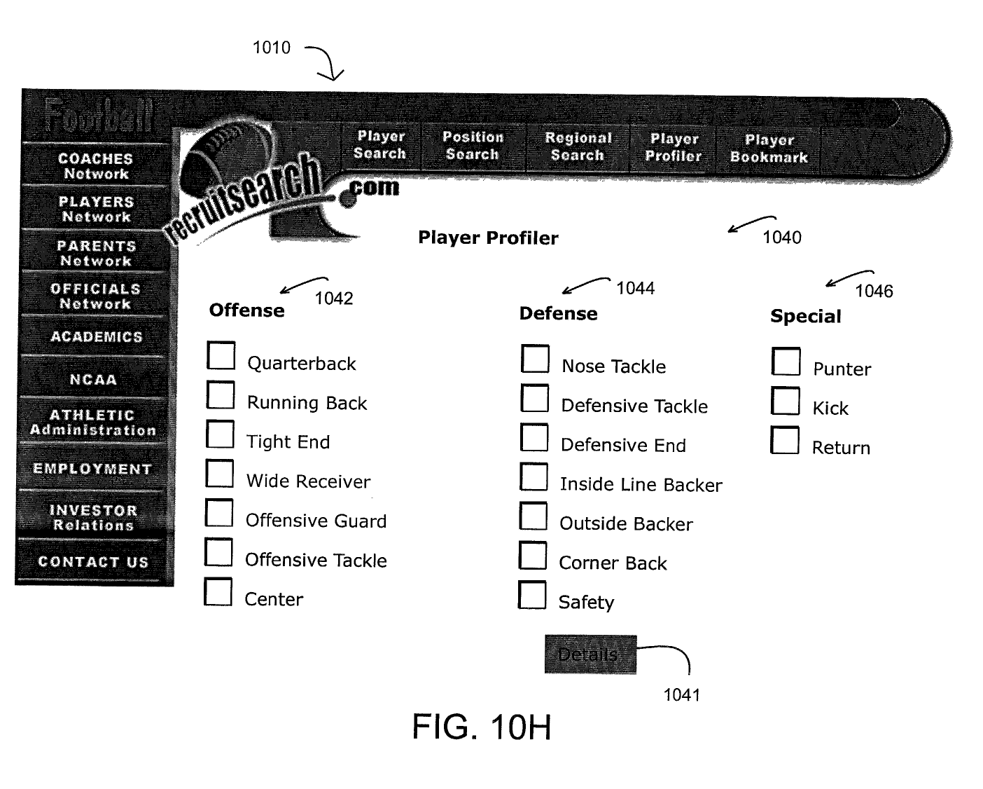

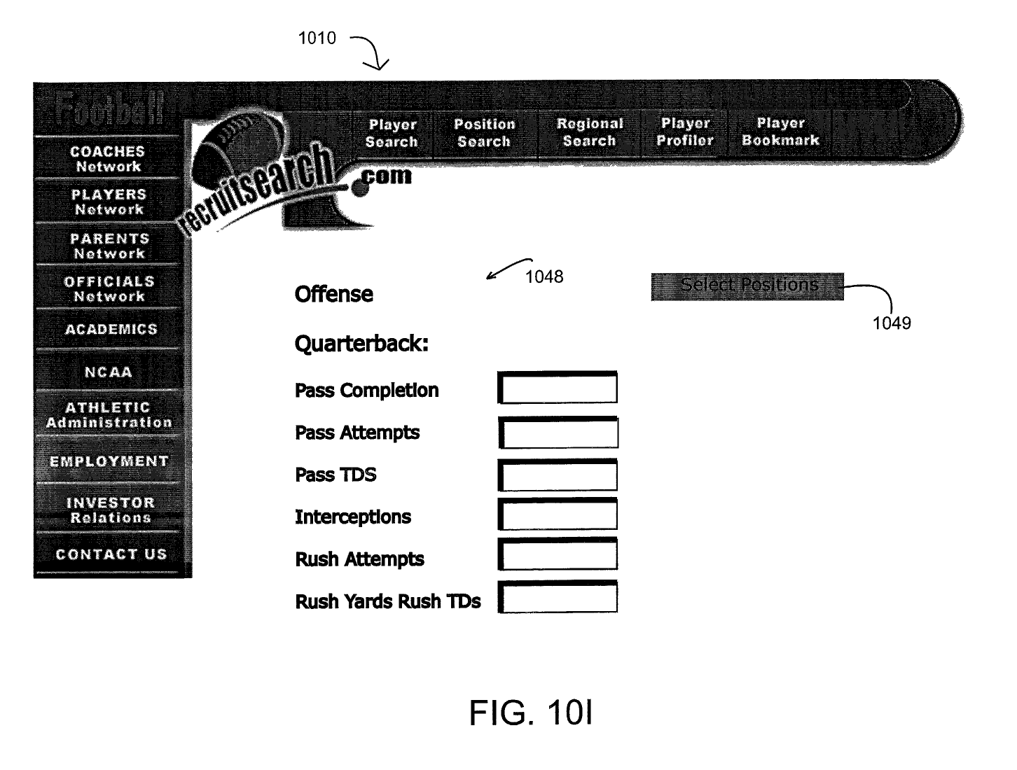

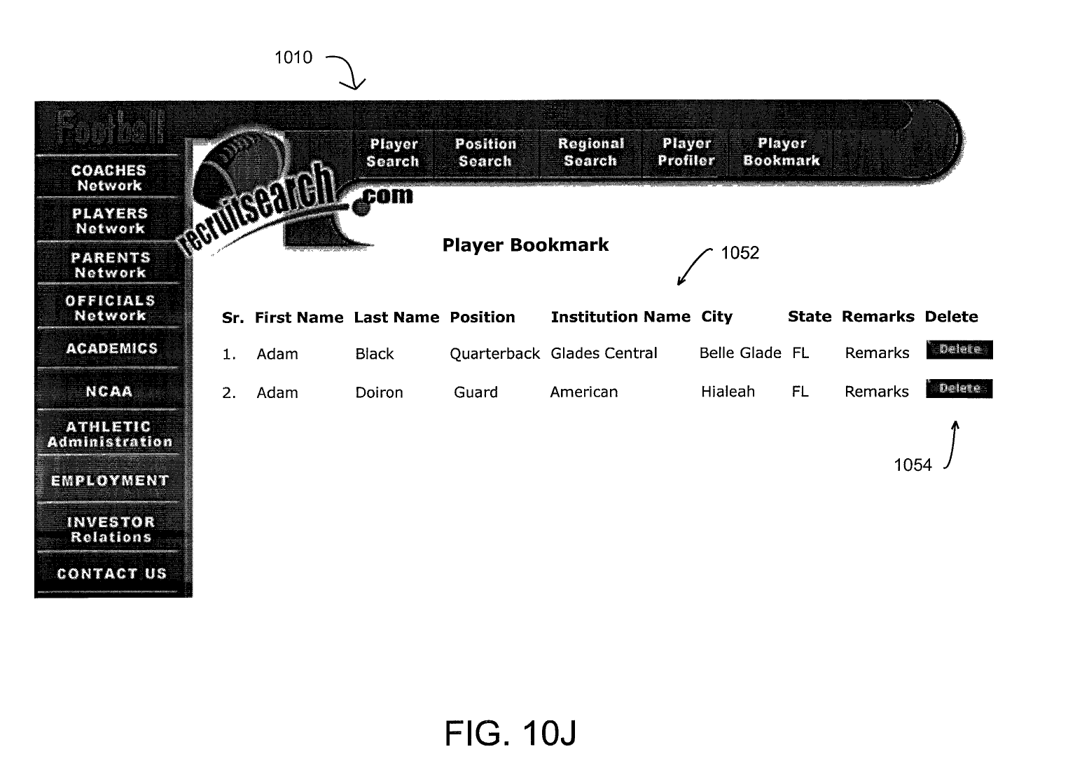

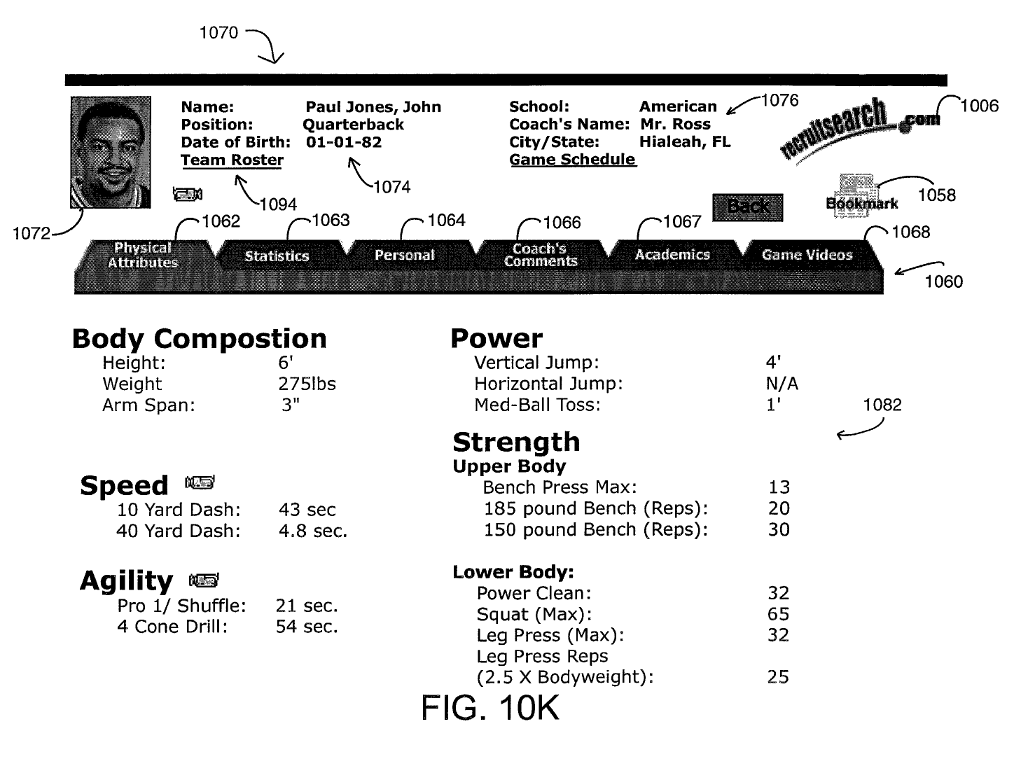

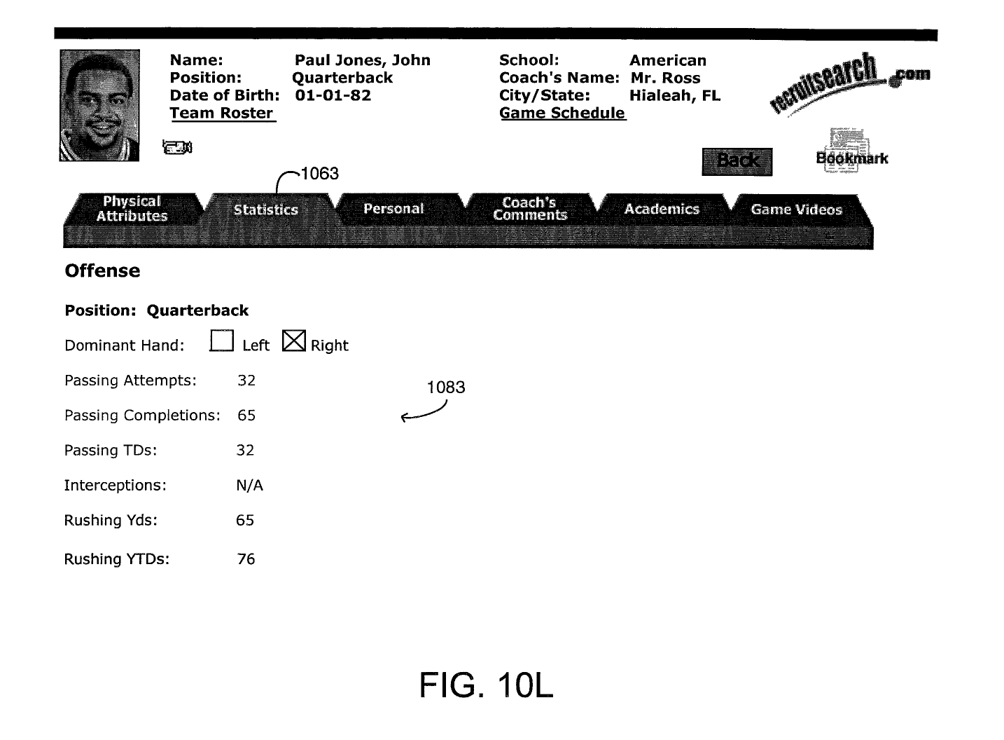

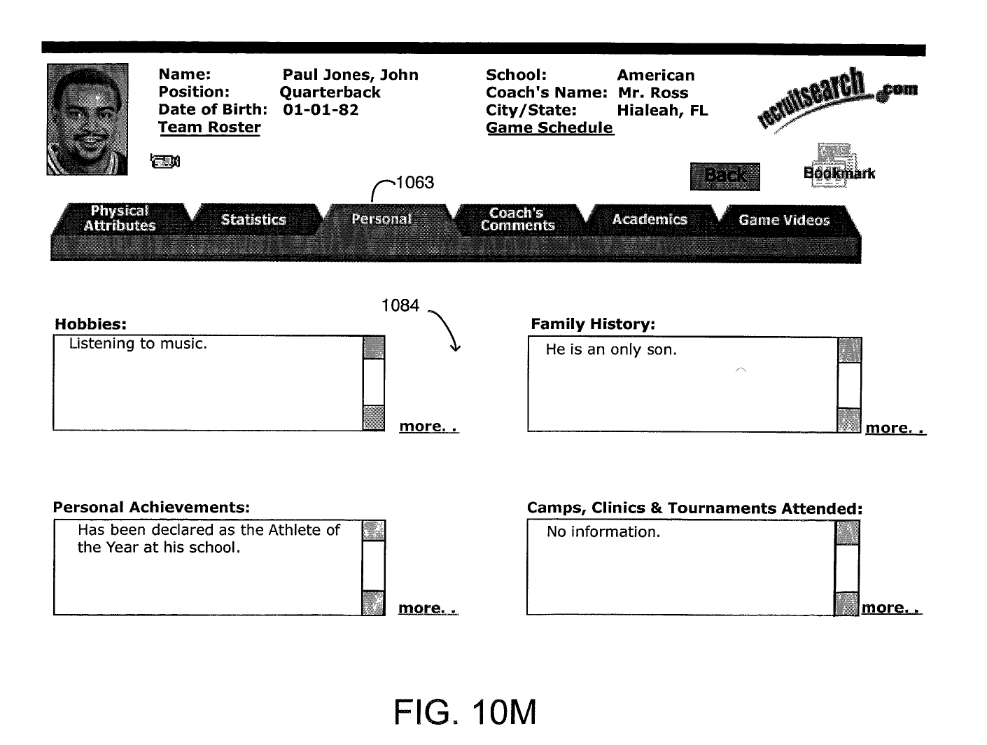

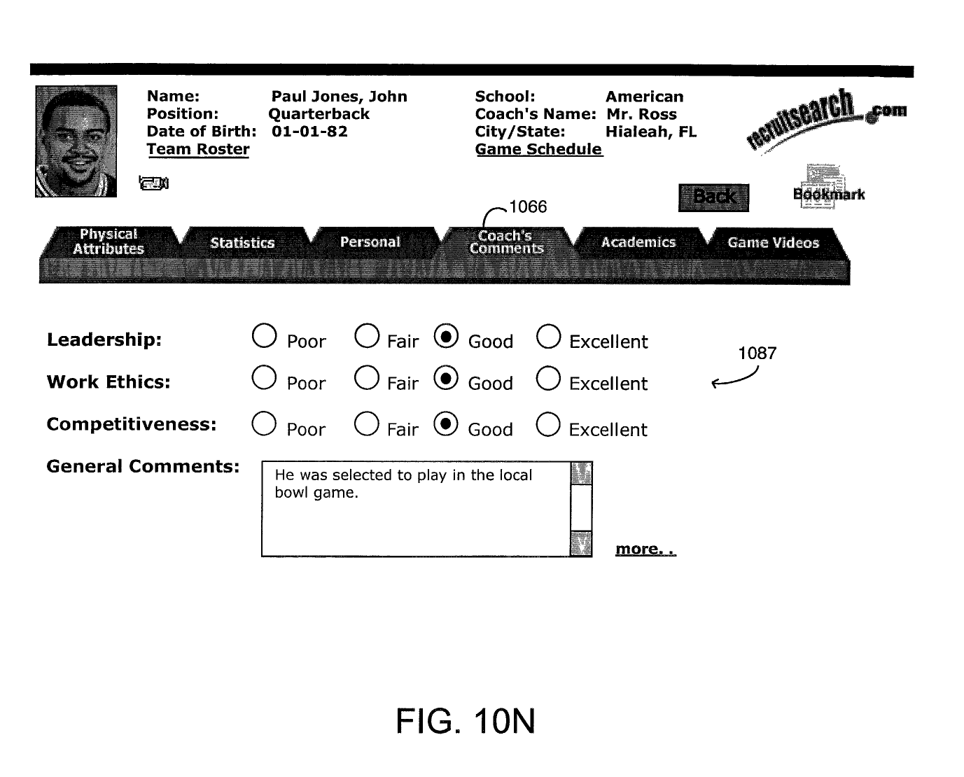

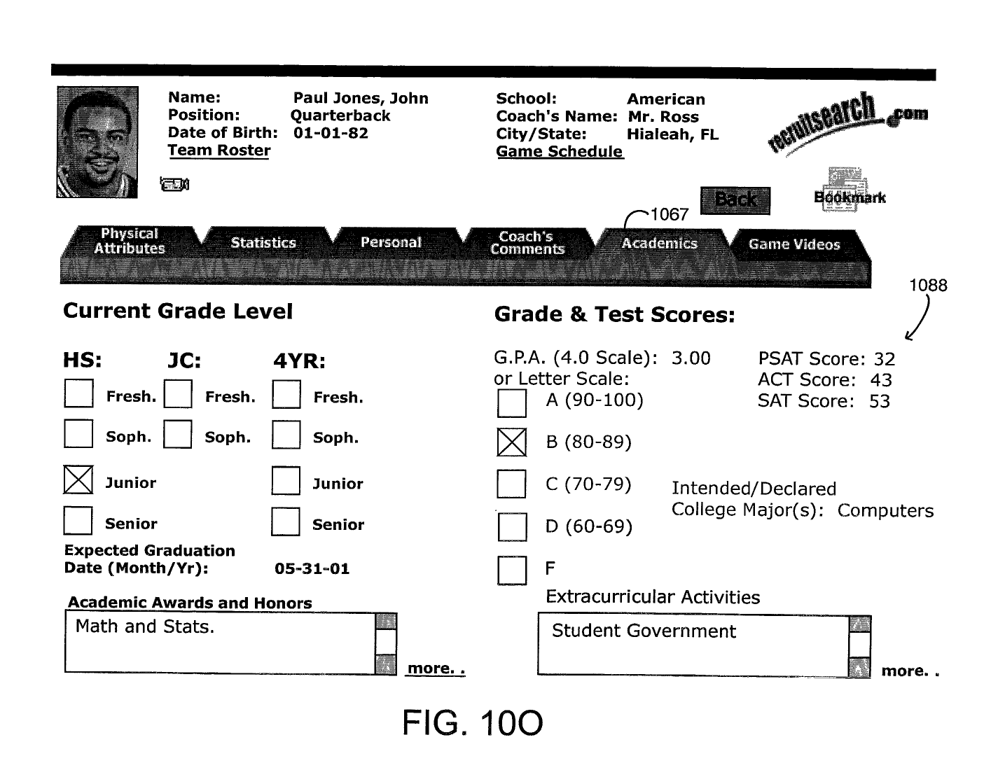

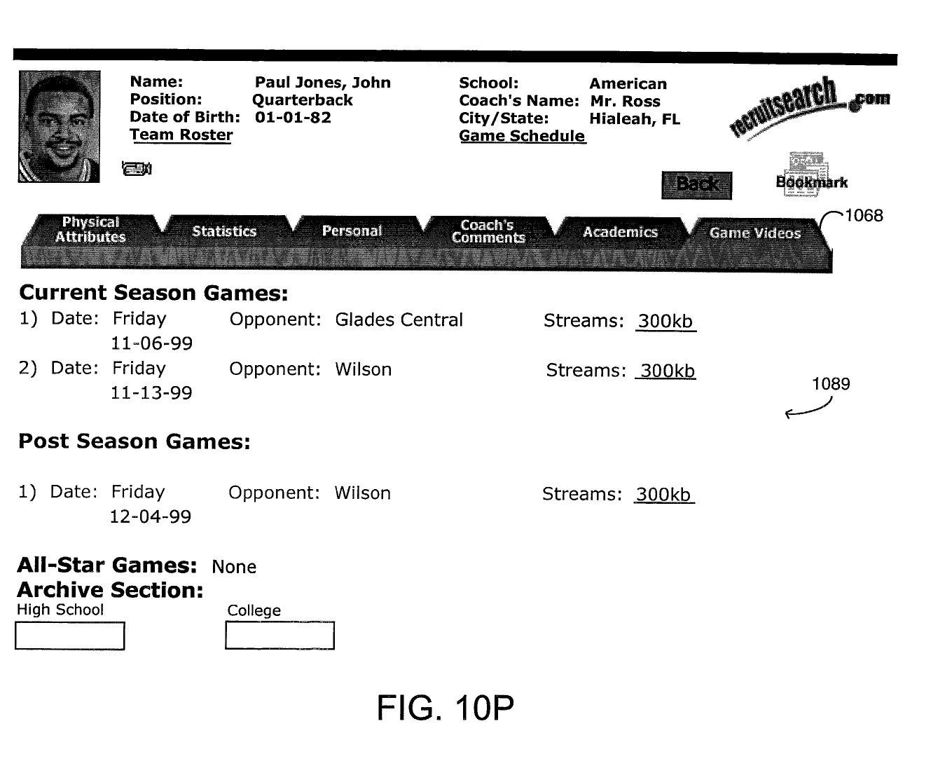

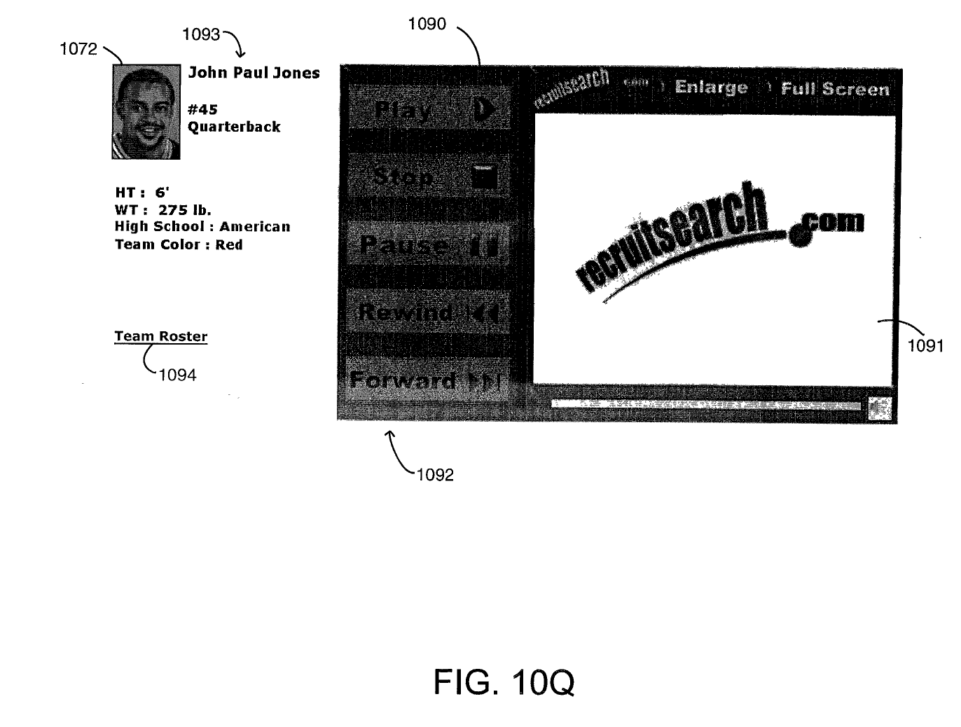

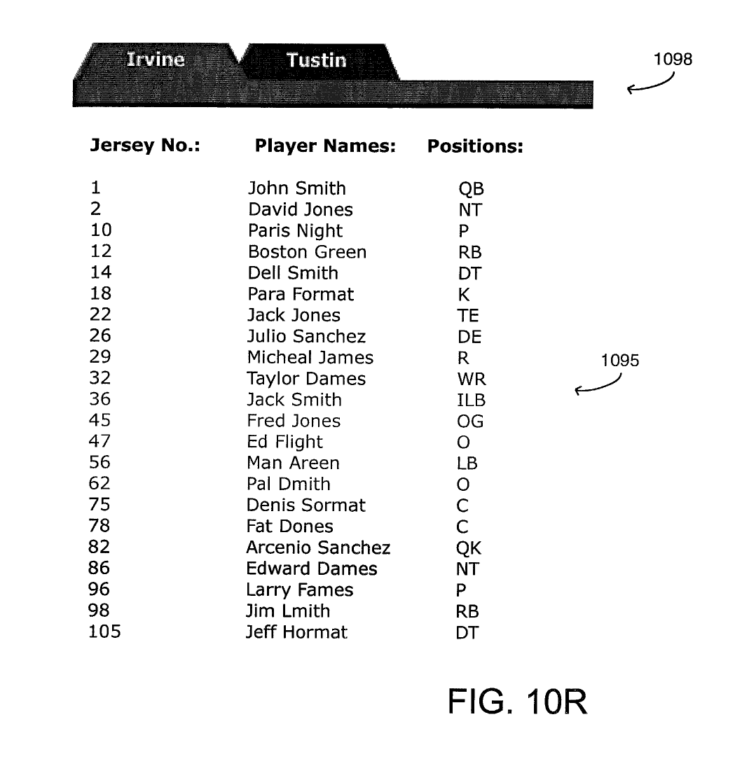

Shown in FIG. 1, a subscriber 110 is typically a university coach or athletic director or a professional team coach or scout. A subscriber 110 connects to the portal 100 by connecting their computer to the Internet 130 and entering the address of the web server 140 into their browser 120. When connected, the web server 140 downloads to the browser 120 web pages that create a graphical user interface (GUI). The GUI, illustrated in FIGS. 10A-R below, prompts the connected subscriber 110 for inputs 112 that form a search query relating to one or more athletes. The GUI also displays 112 the results of this query to the subscriber 110, allowing the subscriber 110 to research a team prospect, as described in further detail below.

Illustrated in FIG. 1, a subscriber's inputs 112 are transmitted 122 over the Internet 130 and uploaded to the web server 140. The web server 140 formulates the subscriber inputs as a search query that is passed 162 to the database server 160. In turn, the database server 160 interprets this query and retrieves 152 corresponding athlete information from the athlete database 150. The athlete information is passed 162 to the web server 140. The web server 140 constructs a corresponding web page that is downloaded 142, 122 via the Internet 130 to the browser 120, to be displayed 112 to the subscriber 110. If the query related to a specific athlete who had video segments stored on the sports video database 170, the browser 120 would display links to these video segments. If the subscriber selected (e.g. with a mouse click) one of these links, the browser 120 would upload 122, 142 this link to the web server 140 and invoke a multimedia player plug-in. The web server would pass 182 the link to the multimedia server 180, which would begin downloading 182 compressed audiovideo data in a streaming (continuous) fashion to the browser 120. The player plug-in would decompress this audio-video data, providing a motion picture on the subscriber's 110 monitor and associated sound, if any, on the subscriber's 110 computer speakers. Although the portal 100 is described above in relationship to remote browser “clients” connected via the Internet to a web server, one of ordinary skill in the art will recognize that the portal can be configured as any remote client communicating across a local-area network (LAN) or a wide-area network (WAN) to one or more servers that access either a central or distributed database to provide recruiting information to a local, nationwide or worldwide subscriber base.

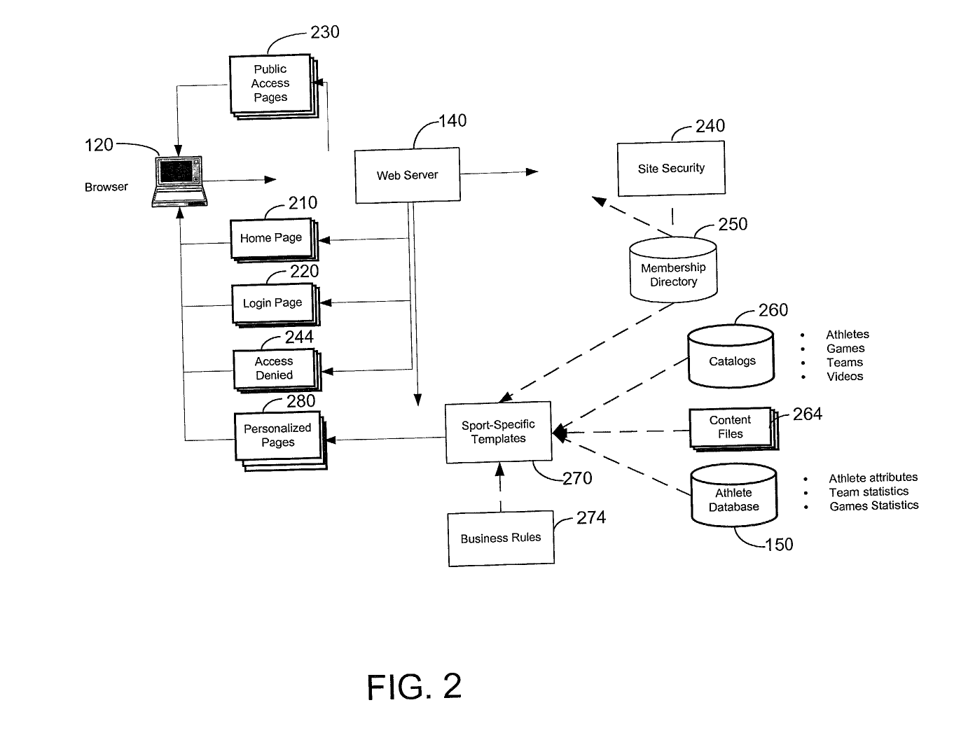

FIG. 2 provides further detail regarding subscriber login to the portal and subsequent access to the athlete database. A user initially contacts the portal website by typing or otherwise selecting its Internet address, e.g. www.recruitsearch.com, through their browser 120. The browser 120 then sends the portal's IP address over the Internet. The portal's web server 140 responds to its address by downloading its homepage 210 to the browser 120. The homepage 210 offers links to the portal's public access pages 230, which are downloaded to the browser 120 at the user's request. The homepage 210 also offers links to login pages 220, which are downloaded to the browser 120 upon user request. In one embodiment, each of the login pages 220 are related to a specific sport of interest, such as football, baseball, basketball or hockey. If the user is a portal subscriber, they enter the requested login information, such as subscriber name and password. The browser 120 uploads the login information to the web server 140, which passes it to site security 240. Site security 240 accesses a membership directory 250 to verify the subscriber information. If the information cannot be verified, the web server 140 downloads an access denied page 244 to the browser 120.

As shown in FIG. 2, if the login information is verified, that is, the user is registered with the portal and has the appropriate access privileges, then the web server 140 constructs personalized pages 280 at the subscriber's request. The personalized pages 280 are constructed from sport-specific templates 270. These templates 270, in turn, are based upon subscriber information and preferences derived from the membership directory 250 and programmed business rules 274. Content for the templates 270 is derived from catalogs 260, which are subject specific indexes of the athlete database 150, content files 264 and the athlete database 150. The web server 140 formats and downloads the personalized pages 280 to the browser 120, providing the subscriber with requested sport recruiting information.

### Search Features

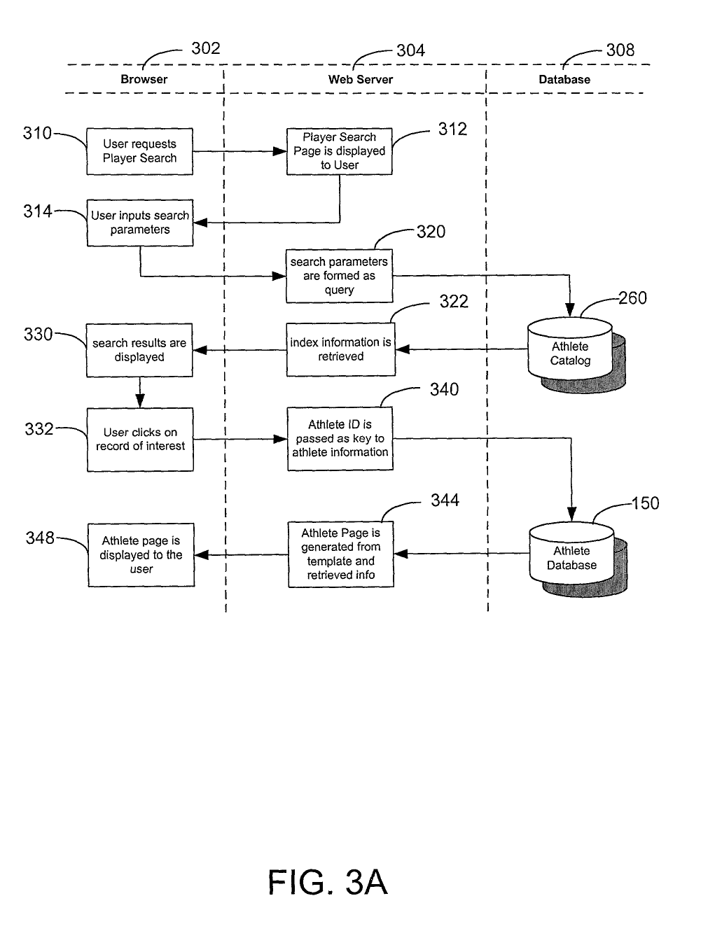

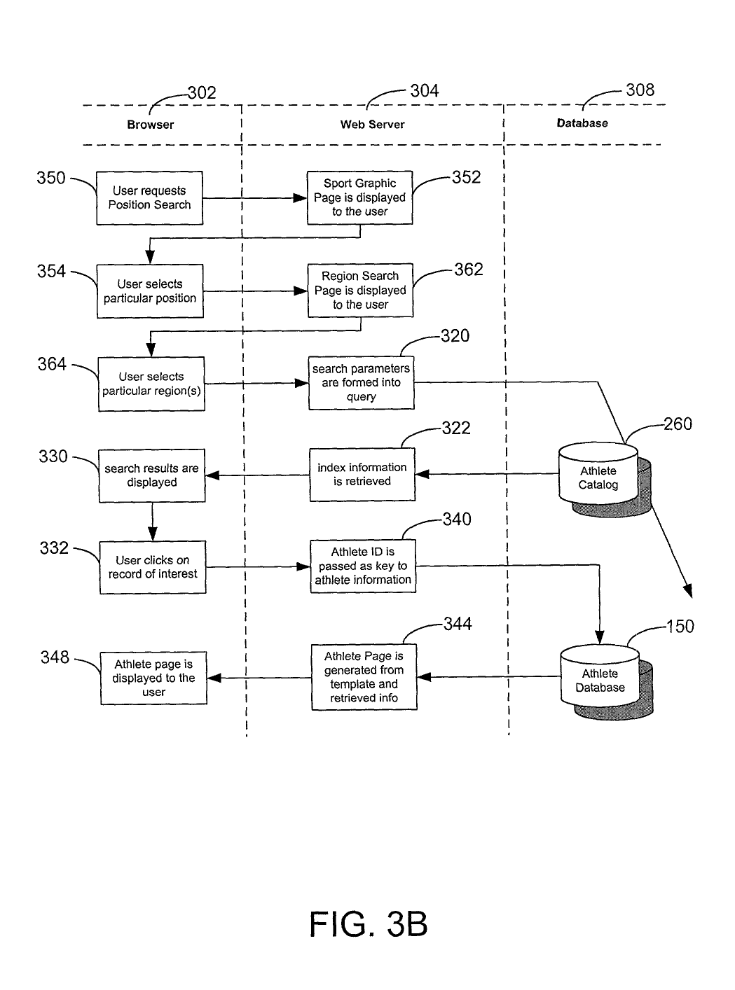

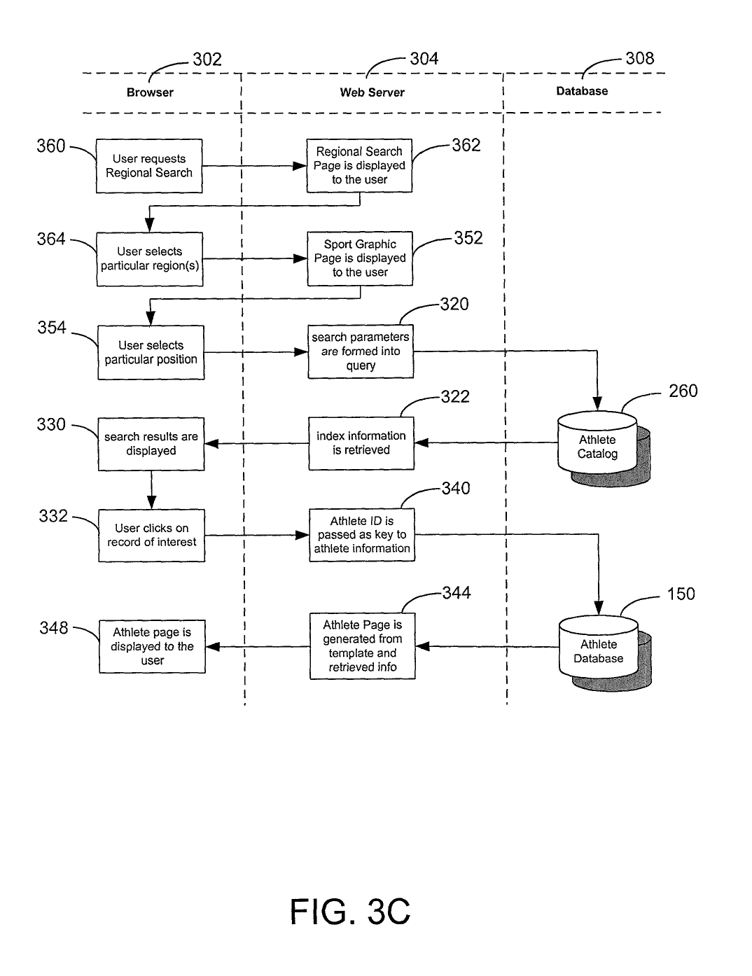

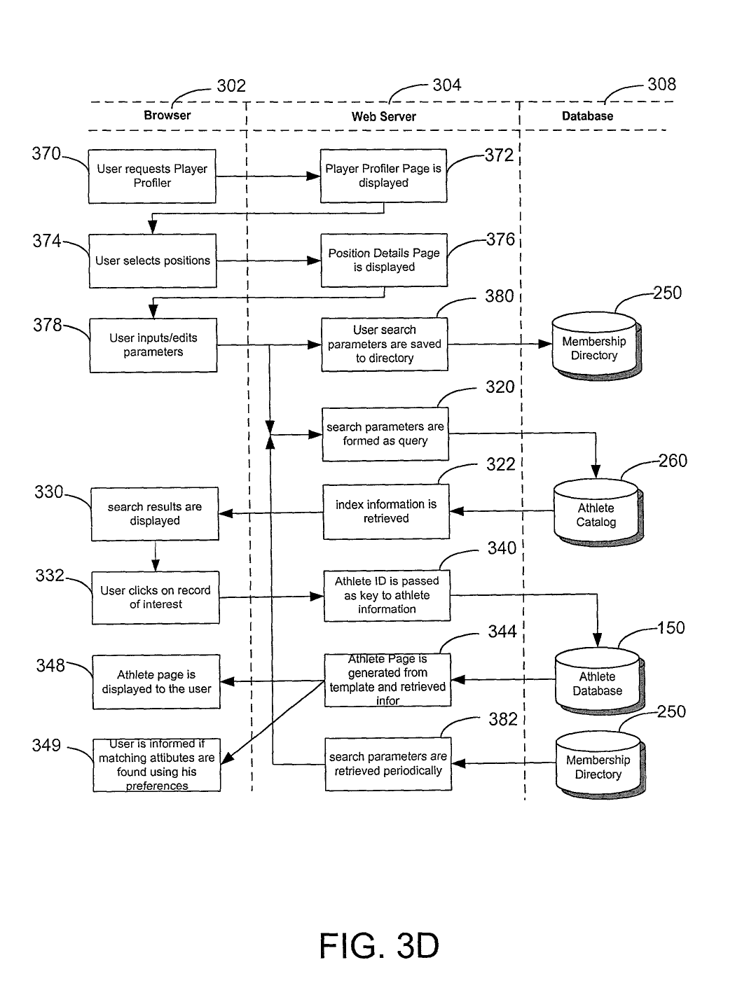

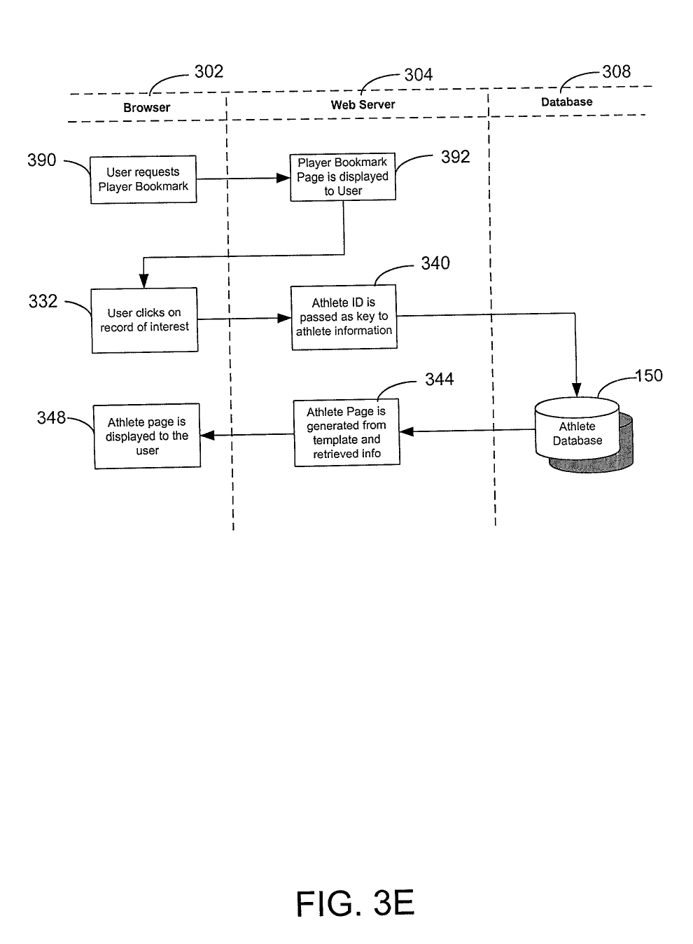

FIGS. 3A-E provide further detail regarding the portal's various search modes, including a player search, a position search, a regional search, a player profiler and a player bookmark. These search modes provide a user-friendly and flexible search across the entire pool of athletes in a particular sport. The player search is a query based on the name of one or more athletes of interest. The position search provides a graphical map of all the positions in a particular sport. A subscriber is able to click on a specific position to initiate a search for athletes that play the position they are actively recruiting. The regional search provides a graphical map of the U.S. with user selectable states and regions. A subscriber is able to click on one or more regions to initiate a search for athletes playing in those regions. The player profiler allows a subscriber to store various player parameters that they are seeking. The database is periodically searched for athletes that correlate to these parameters, and the subscriber is notified when such a match is found. These parameters are performance statistics based upon both the sport and position played. The player bookmark allows a subscriber to save the identifying information for a particular athlete found using one of the other search modes. The identifying records of all bookmarked players are then recalled upon request. The user can select one or more of these records to obtain a review or update on an athlete. FIGS. 10D-J illustrate one embodiment of the GUI for these five search modes using football as the sport of interest.

### Player Search

FIG. 3A illustrates the information flow between browser 302, web server 304 and database 308 for the player search mode. The flow diagram begins after the subscriber (user) has successfully completed the login process for the portal, as described above with respect to FIG. 2. After login, the browser 302 presents the user with a search mode page, which is a GUI prompting the user to select, among other items, one of five search modes. One embodiment of the search mode page is illustrated in FIG. 10C, described below. The user requests a player search 310 by clicking a player search button on the search mode page. This request causes the web server 304 to download the player search page 312 to the browser 302 for user display. One embodiment of a player search page is illustrated in FIG. 10D, described below. The player search page is a GUI that prompts the user for athlete search parameters, such as name, region and school. The user enters these search parameters 314, which the web server 304 forms into a query 320. The athlete catalog 260 is searched based on this query and the corresponding catalog information is retrieved 322. The web server 304 downloads these search results to the browser 302, which displays the results to the user 330. One embodiment of the player search results page is illustrated in FIG. 10E, described below. The user clicks on a record of interest 332. The corresponding athlete ID is used to request athlete information 340 from the athlete database 150. The athlete page is generated using a template and the retrieved athlete information 344. The athlete page is then downloaded to the browser 302 and displayed to the user 348. One embodiment of an athlete page is shown in FIGS. 10K-P, described below.

### Position Search

FIG. 3B illustrates the information flow between browser 302, web server 304 and database 308 for the position search. As described above with respect to FIG. 3A, the flow diagram begins after the user has successfully completed login and is presented with the search mode page GUI, such as illustrated in FIG. 10C, to select one of five search modes. The user requests a position search 350 by clicking a position search button on the search mode page, for example. This request causes the web server 304 to download the sport graphic page 352 to the browser 302 for user display. One embodiment of a football version sport graphic page is illustrated in FIG. 10F, described below. The sport graphic page presents the user with a graphic depiction of the playing field for a particular sport, such as a football field, a basketball court or a baseball diamond and outfield, along with the associated positions. The user then selects a particular position 354 by clicking on the graphic associated with that position. This request initiates the web server 304 to download the regional search page 362 to the browser 302 for user display. One embodiment of a regional search page is illustrated in FIG. 10G, described below. The regional search page presents the subscriber with a US map. This allows the user to select a particular area of the country 364 by clicking on one or more specific states or by clicking a particular named region, such as the “Pacific West” or the “Mid-Atlantic.” The user's selections from the sport graphic page and the regional search page, i.e. a player's position and one or more US regions, are formed into a search query 320. The athlete catalog 260 is searched based on this query and the catalog information retrieved 322. The web server 304 downloads the search results to the browser 302, which displays the results to the user 330. The displayed results are as illustrated in FIG. 10E, described below. The user clicks on a record of interest 332. The corresponding athlete ID is used to request athlete information 340 from the athlete database 150. The athlete page is generated using a template and the retrieved athlete information 344. The athlete page is then downloaded to the browser 302 and displayed to the user 348, such as shown in FIG. 10K-P, described below.

### Regional Search

FIG. 3C illustrates the information flow between subscriber 302, web server 304 and database 308 for the regional search. The regional search corresponds to the position search described above with respect to FIG. 3B, except that the regional search page, e.g. FIG. 10G, is presented to the user before the sport graphic page, e.g. FIG. 10F. The user requests a regional search 360 by clicking a regional search button on the search mode page (FIG. 10C), for example. This request causes the web server 304 to download the regional search page for user display 362 to the browser 302. The user then selects one or more regions 364 by clicking on a corresponding portion of the US map graphic or on a region description. This request initiates the web server 304 to download the sports graphic page for user display 352 to the browser 302. The user then selects a position 354 by clicking on a corresponding portion of the playing field graphic. The user's selections from the regional search page and sport graphic page, i.e. one or more US regions and a player's position, are formed into a search query 320. The athlete catalog 260 is searched based on this query and the catalog information retrieved 322. The web server 304 downloads the search results to the browser 302, which displays the results to the user 330, such as illustrated in FIG. 10F. The user clicks on a record of interest 332. The corresponding athlete ID is used to request athlete information 340 from the athlete database 150. The athlete page (FIGS. 10K-P) is generated using a template and the retrieved athlete information 344. The athlete page is then downloaded to the browser 302 and displayed to the user 348.

### Player Profiler

FIG. 3D illustrates the information flow between browser 302, web server 304 and database 308 for the player profiler. As described above with respect to FIG. 3A, the flow diagram begins after the user has successfully completed login and is presented with the search mode page GUI, such as illustrated in FIG. 10C, to select one of five search modes. The user requests the player profiler 370 by clicking a player profiler button on the search mode page, for example. This request causes the web server 304 to download the player profiler page for user display 362. One embodiment of the player profiler page is shown in FIG. 10H, described below. The user then selects one or more positions 374 by clicking on a corresponding description. This request initiates the web server 304 to download the position details page for user display 376 to the browser 302. An example of a position details page for football and the quarterback position is shown in FIG. 101, described below. The position details page provides labeled fields for the user to enter various statistical parameters appropriate to the selected sport and position, such as pass completions and interceptions for a quarterback. The user inputs these parameters or edits previously entered parameters 378. The user's entered parameters are saved 380 to the membership directory 250. Further, the user's entered parameters are used to form a search query 320. In this case, the search query is formulated to locate athletes whose statistics meet the minimum requirements of all of the entered parameters. The athlete catalog 260 is searched based on this query and the catalog information retrieved 322. The web server 304 downloads the search results to the browser 302, which displays the results to the user 330, such as illustrated in FIG. 10E. The user clicks on a record of interest 332. The corresponding athlete ID is used to request athlete information 340 from the athlete database 150. The athlete page (FIGS. 10K-P) is generated using a template and the retrieved athlete information 344. The athlete page is then downloaded to the browser 302 and displayed to the user 348. Alternatively, if the user is not online, the user is informed if an athlete with matching attributes is found 349 during a periodic search. The web server 304 periodically retrieves a user's search parameters 382 and utilizes these parameters to form a query 320.

### Player Bookmark

FIG. 3E illustrates the information flow between browser 302, web server 304 and database 308 for the player bookmark search. As described above with respect to FIG. 3A, the flow diagram begins after the user has successfully completed login and is presented with the search mode page GUI, such as illustrated in FIG. 10C, to select one of five search modes. The user requests a player bookmark 390 by clicking a player bookmark button on the search mode page. This request causes the web server 304 to download the player bookmark page 392 to the browser 302 for user display. One embodiment of a player bookmark page is illustrated in FIG. 10J, described below. The player bookmark page is a GUI that presents the user with records identifying all previously bookmarked players that have not been deleted from the bookmark page. In one embodiment, the identifying information displayed is an athlete's name, position, institution name, city and state. The user clicks on a record of interest 332. The corresponding athlete ID is used to request athlete information 340 from the athlete database 150. The athlete page is generated using a template and the retrieved athlete information 344. The athlete page is then downloaded to the browser 302 and displayed to the user 348.

### Multimedia Sport Segments

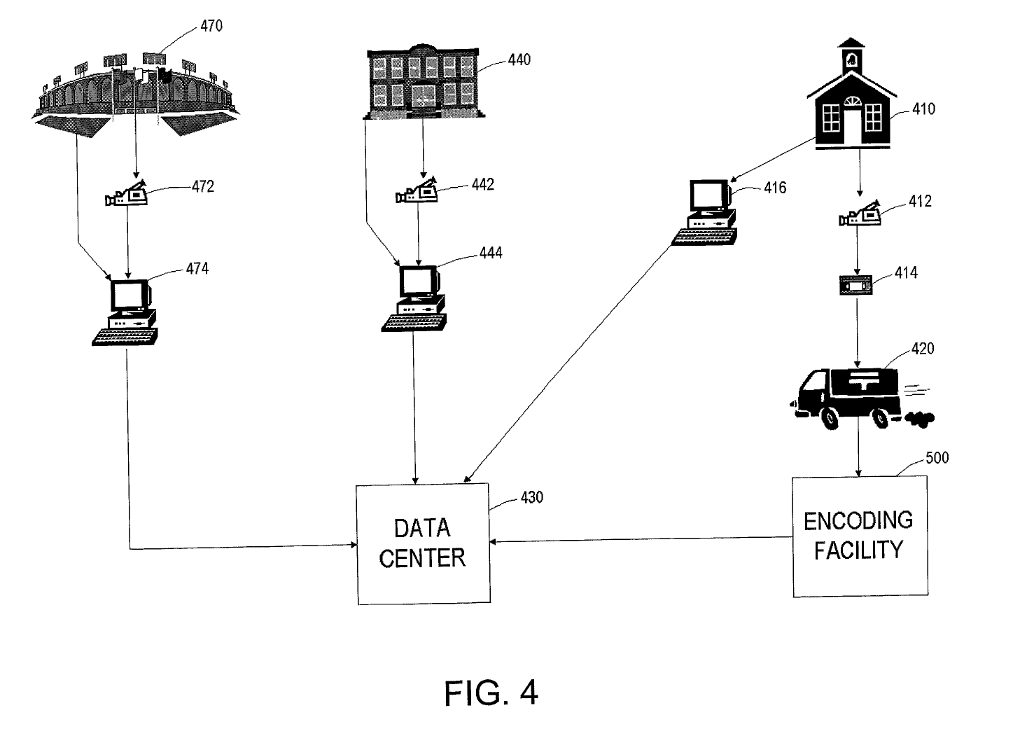

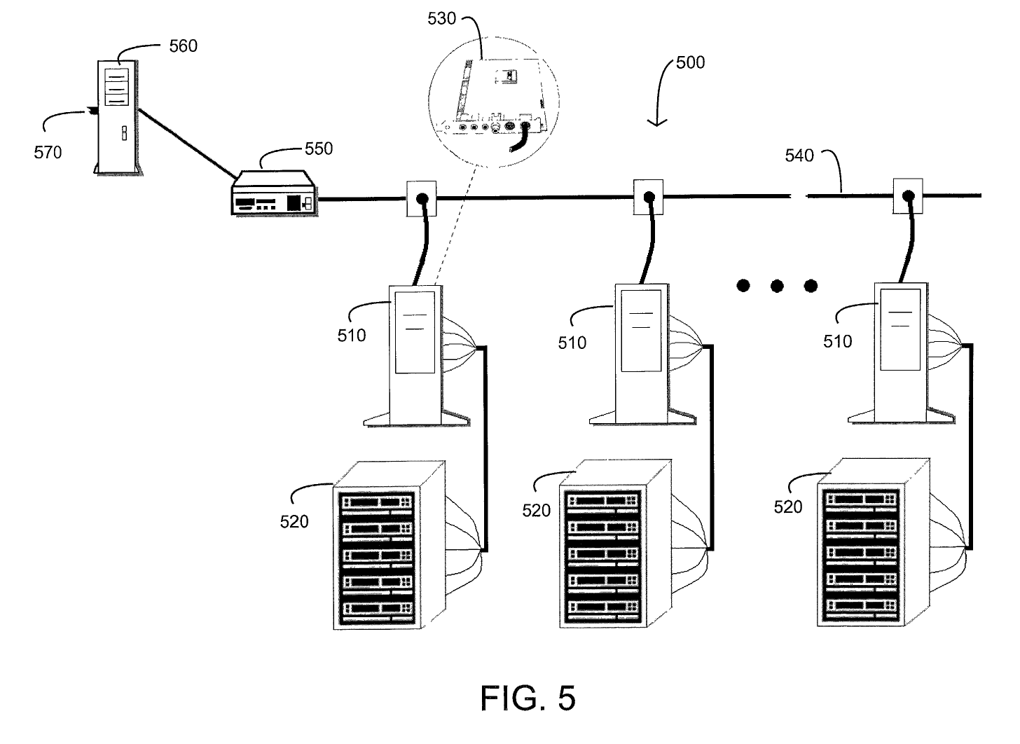

As described above, one aspect of the present invention is providing on demand multimedia sports segments, including at least audio-video clips, featuring particular athletes of interest to the sport recruiting professional. This requires multimedia production, processing and delivery. In particular, the steps involved in transferring sports videos from the playing field to the subscriber include recording, transporting, capturing (digitizing and storing), editing, encoding, uploading, archiving, retrieving, downloading and playing these multimedia segments. FIG. 4, described in detail below, depicts the first of these steps. FIG. 5, also described in detail below, depicts the capturing, editing, encoding and uploading steps. FIG. 1, described in detail above, depicts the retrieval, downloading and playing steps.

### Multimedia Production

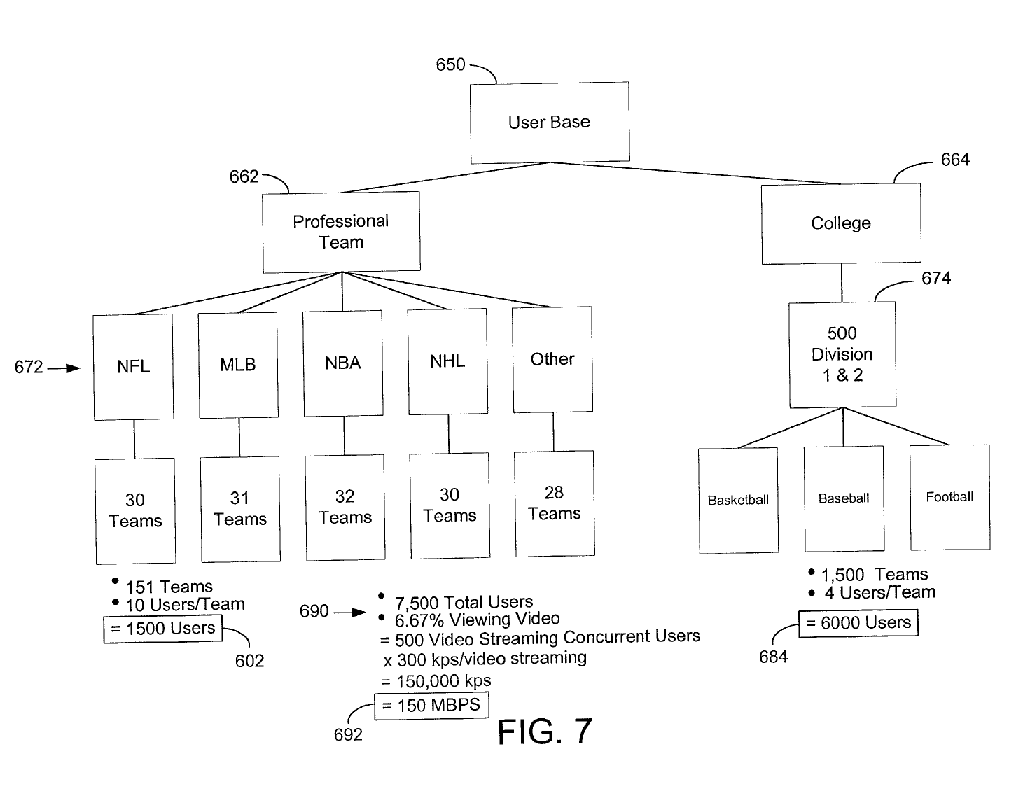

FIG. 4 provides an overview of the steps involved in the production of multimedia sports segments. The recording process is straightforward. At the high school level 410, a conventional analog video camera 412 is typically used to make conventional video tapes 414 (e.g. VHS tapes) of sporting events featuring athletes that are prospective recruiting candidates. These tapes are transported 420 by U.S. mail or express delivery service to an encoding facility 500. At the encoding facility 500, described below with respect to FIG. 5, the content of these tapes is captured, edited and encoded. Encoded video is then uploaded to a data center 430 that physically houses the portal website hardware, described below with respect to FIG. 7. At the data center 430, the encoded video data files are then archived in a video database 170 (FIG. 1). Further, high school staff utilizes a conventional personal computer 416 to upload information on particular athletes that becomes part of the athlete database 150 (FIG. 1).

As shown in FIG. 4, at the university level 440 more expensive video recording and computer equipment is likely available. A conventional digital video camera 442 is utilized to record player events. A computer 444 located at the university 440 is utilized to upload digitized video files from the camera 442. These files are edited and encoded locally and uploaded directly to the data center 430, bypassing the encoding center 500. Of course, the same process of recording VHS, 8 mm or similar standard format tapes could be utilized as described above with respect to high school level sports. The same computer equipment 444 is also utilized by university staff to upload information on particular athletes that becomes part of the athlete database 150 (FIG. 1). Also shown in FIG. 4, at the professional level 470 sophisticated recording 472 and editing equipment 474 is available to perform all of the functions described above with respect to university level 440 sports.

### Multimedia Processing

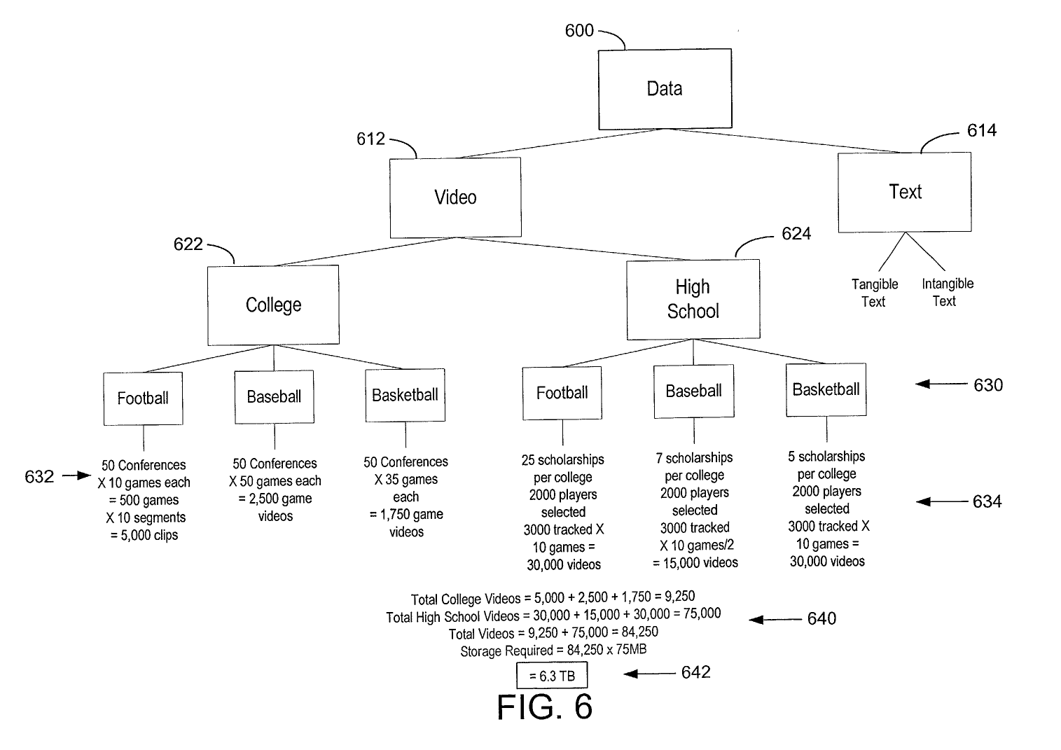

FIGS. 5, 6 and 7 relate to the processing of the multimedia sport segments. In particular, FIG. 5 depicts a facility for capturing, encoding and uploading sport videos. FIGS. 6 and 7 illustrate the computations of the storage and bandwidth requirements for these videos, respectively. The encoding step is important to minimize both the storage and bandwidth of the multimedia segments. Broadcast-quality video requires 160 Mbps (megabits per second). Compact disc quality audio requires approximately 2.8 Mbps. An uncompressed video file, such as an AVI format, requires 1.5 Mbps. A 40 second long AVI video would require about 8 MB of storage and would take about 40 minutes to download at 128.8 Kbps (kilobits per second), the connection speed of many modems used on the Internet. Compression and encoding allow high-quality multimedia information to be stored, downloaded and played over the Internet.

In one embodiment, after digitization, multimedia information is encoded in ASF format. ASF is designed to work with Microsoft Windows Media Player. ASF supports streaming media, which allows audio, video and other multimedia available in real-time, with no download wait. That is, with ASF, a video can begin playing at the user's browser after only of few seconds of download. In this manner, files can be of almost arbitrary length and run at Internet bandwidths. Windows Media utilizes separate voice, music and video codecs (compressor/decompressor). The video codec utilizes the MPEG (Motion Picture Experts Group) video coding standard. ASF is a file format that stores the information produced by these three codecs. ASF files can be viewed on a user browser by launching a standalone player, Microsoft Windows Media Player.

FIG. 5 illustrates the encoding center 500, which is a central depository of sport video tapes and is utilized as a facility to capture and encode multimedia segments and to upload these encoded segments to the portal. The encoding center 500 consists of a series of encoding stations 510 each connected to a rack of VCRs 520. Each encoding station 510 is a computer, with a bank of video capture cards 530 plugged into the computer's motherboard. In each encoding station 510 there is one video capture for each VCR in the VCR rack 520. A cable connects the S-video output of each VCR in the VCR rack 520 to the S-video input of one of the video capture cards 530. Each of the encoding stations 510 is connected to a local area network (LAN) 540, such as an Ethernet, utilizing a network card plugged into the computer's motherboard. A switch 550 interconnects the encoding stations 510 to a central network server 560. The server 560 is routed 570 to a high-speed Internet connection via a firewall (not shown).

As shown in FIG. 5, each encoding station 510 is utilized to capture, edit and encode various sport video tapes received at the encoding center 500. A received video tape is loaded into one of the VCRs 520 and played to a video capture card 530. Each video capture card 530 digitizes the VCR video output, storing the video on a hard drive located in the encoding station. The digitized video is edited for content by an operator and encoded. Encoded videos are uploaded from each encoding station over the LAN 540 to the network server 560. The network server 560 then periodically uploads encoded videos to the portal data center 430 (FIG. 4). In one embodiment, the video capture card 530 is Winnov Videum AV card, the editing software is Adobe Premiere 4.0, and the encoding software is VivoActive Producer for Windows Media Services, available from Vivo Software.

FIG. 6 depicts the yearly storage requirements for the sport video database 170 (FIG. 1). The data storage 600 consist of videos 612 and text 614. Because the video storage requirements far exceed the text storage requirements, only the video data storage 612 is considered here. The videos 612 consist of tapes from the collegiate 622 and high school 624 levels. The three major sports 630 within each of these levels 622, 624 are football, baseball and basketball. At the collegiate level 622, the yearly video production 632 is based upon the number of conference games in each season. At the high school level 624, the yearly video production 634 is based upon the number of scholarships available and the pool of players tracked for those scholarships. Hence, the total number of videos produced per year 640 is estimated at 84,250. At 75 MB storage required for each video, the estimated yearly storage requirement 642 for the sports video database is 6.3 TB. This storage estimate, in turn, dictates the data storage hardware utilized for the sports video database, as described below with respect to FIG. 7.

FIG. 7 depicts the bandwidth requirements for the sport video database 170 (FIG. 1). The total bandwidth is a function of the number of concurrent users and the bandwidth required to play each requested video. At the top level, the bandwidth is dependent on the user base 650, which is composed of recruiting professionals for professional teams 662 and for collegiate teams 664. On the professional side 662, there are users associated with each of the major sport leagues 672. On the collegiate side, there are the Division 1 and 2 colleges 674. The professional leagues 672 comprise a total of 151 teams. At 10 users per team, this yields a total 682 of 1500 users. The three major collegiate sports comprise a total of 1,500 teams. At 4 users per team, this yields a total 684 of 6000 users. Estimating 6.67% of the total users 682, 684 viewing multimedia segments from the portal at any one time, results in a total 690 of 500 concurrent users. At 300 Kbps for each streaming video, the resulting download requires a bandwidth 692 of 150 Mbps. This bandwidth estimate, in turn, dictates the video delivery hardware and the type of connection between the delivery hardware and the Internet, as described below with respect to FIG. 7.

### Multimedia Delivery

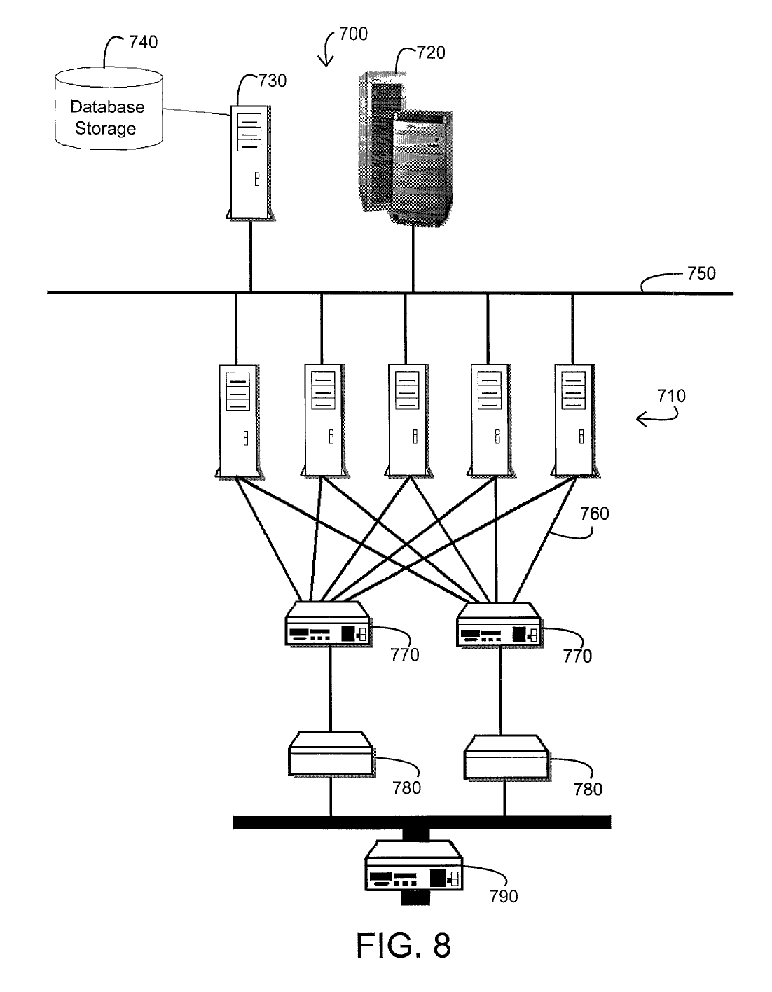

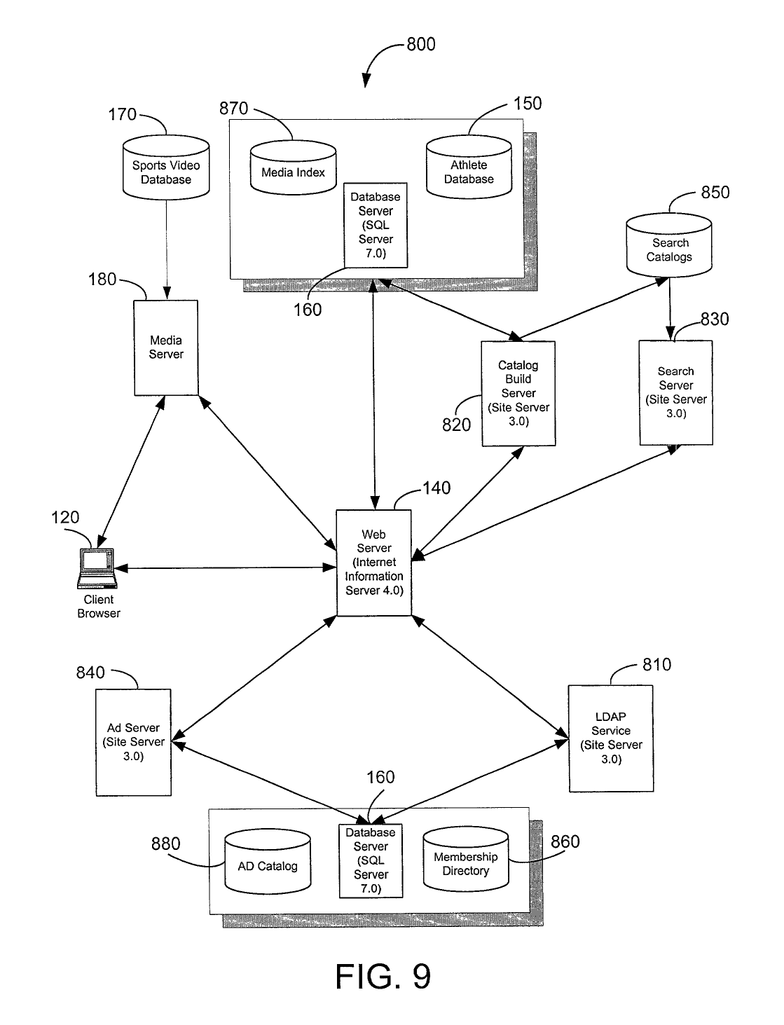

FIG. 8 illustrates one embodiment of the website hardware configuration 700 for the portal. The website hardware configuration 700 includes web servers 710, video storage 720 and a database server 730 linked over a network 750. The database server 730 accesses database storage 740. The web servers 710 are interconnected to the Internet via switches 770, routers 780 and a switch 790 to one or more leased lines connecting to an Internet backbone. The web servers 710 run the web server 140 (FIG. 9), site server 820-840 (FIG. 9) and media server 180 (FIG. 9) software, described below. The web servers 710 are one or more processor platforms designed for server applications, such as Compaq® Proliants. The servers 710 are configured for load balancing among the individual processor platforms. Applicable load balancing techniques, which are well-known in the art, include DNS round-robin distribution, interactive load balancing or third-party load-balancing solutions (e.g. Cisco® Local Director or Alteon® Ace Director).

Shown in FIG. 8, the video storage 720 stores the sport video database 170 (FIG. 1), described above. The video storage 720 is a disk array (e.g. RAID) configured for the video storage capacity and bandwidth requirements described above with respect to FIGS. 6-7, such as available from Compaq® (e.g. Enterprise Storage Array 12000) or Network Appliance® (e.g. F760). The database server 730 is one or more server processor platforms, such as the Proliants referenced above. The database storage 740 is one or more hard disks, which are typically internal to the server processors. The database server 730 runs the database server 160 (FIG. 9) software. The database storage 740 stores the athlete database 150 (FIG. 1), described above.

Illustrated in FIG. 8, the network 750 is configured to support the bandwidth described above with respect to FIG. 7, such as a 1-gigabit Ethernet. The leased lines running from the switch 790 are one or more high-speed telephone lines, such as a DS3 providing 44.736 Mbps. The switch 790 routes outgoing traffic among the multiple lines. The routers 780 function to route data packets between the Internet and the switches 770. The switches 770 distribute incoming traffic among the multiple web servers 710 and outgoing traffic to the routers 780. One of ordinary skill in the art will recognize many variations of the website hardware configuration 700 that are capable of implementing the recruiting portal according to the present invention.

FIG. 9 illustrates one embodiment of the website software configuration 800 for the portal. The website software configuration 800 includes a client browser 120, web server 140, database server 160, media server 180, athlete database 150 and sports video database 170, all as described above with respect to FIG. 1. In addition, the software configuration 800 includes components of a site server including a LDAP service 810, a catalog build server 820, search server 830 and an ad server 840.

As shown in FIG. 9, the LDAP service 810 uses the Lightweight Directory Access Protocol, which is an Internet standard for directory services. Directory services are used to look up information on a network much like a phone book is used to look up a person's name and address. The LDAP service 810 uses this protocol with respect to the membership directory 860, which stores all membership (subscriber) information. The membership directory 860 is stored in a database server 160 database, but LDAP is used to translate all requests into SQL (Structured Query Language) queries.

Also shown in FIG. 9, the catalog build server 820 is used to “crawl” the athlete database 150 on database server 160 to build search catalogs 850. Specifically, the catalog build server 820 creates HTML pages from queries to the database server 160 and crawls the resulting pages to create an index of the database 150. The search server 830 uses the catalogs 850 created by the build server 820 to satisfy user search requests. Specifically, the search server 830 obtains a query from the user, looks up the query in the catalog and returns the results to the user, such as described above with respect to portions of FIGS. 3A-E.

Also illustrated in FIG. 9, the media index 870 provides links between information retrieved from the athlete database 150 to related sports clips stored in the sports video database 170 and retrieved via the media server 180. The ad server 840 is a standalone feature that works in conjunction with an ad catalog 880 to deliver ads to users on the web, such as banner ads and button ads.

The various servers described above are available from Microsoft®. For example, the processor platforms 710 (FIG. 8) can run the Windows NT 4.0 operating system, which supports Internet Information Server 4.0 as the web server 140, SQL Server 7.0 as the database server 160, Windows Media Services Server as the media server 180, and Site Server 3.0 as the LDAP service 810, catalog build server 820, search server 830 and ad server 840.

### Graphical User Interface

FIGS. 10A-R illustrate the graphical user interface (GUI) pages that the portal downloads to a browser for display on a subscriber's computer monitor. FIGS. 10A-B depict the login pages that the portal displays to the subscriber. FIGS. 10C-J depict the search related pages displayed to the subscriber. FIGS. 10K-P depict the athlete information pages. FIG. 10Q depicts the multimedia segment display page, and FIG. 10R depicts the associated team roster page.

### Login

FIG. 10A illustrates the portal home page. The home page features a set of sport-specific buttons 1002 across the top of the page and a set of public-access buttons 1004 down the left-side of the page. A logo 1006 identifying the portal is displayed between the button sets 1002, 1004, and a decorative sport collage 1008 is featured in the page center. Each of the individual buttons in the button sets 1002, 1004 can be selected with a “click” of a user's mouse to initiate an action by the portal web server. The public-access buttons 1004 can be selected without login privileges to initiate display of public-access pages 230 (FIG. 2). The public access buttons 1004 initiate various bulletin board or chat room features (e.g. the coaches, players, parents and officials “network”) or various administrative features (e.g. employment, “contact us”). The sport-specific buttons 1002 initiate the login process for a subscriber enrolled with access privileges for that specific sport (e.g. football, baseball, basketball).

FIG. 10B illustrates a sport-specific (e.g. football) login page. This login page follows the selection of one of the sport-specific buttons 1002 (FIG. 10A). The login page features a sport-indicative graphic 1012 suggesting the selected sport, such as the picture of an individual football player shown. A sport-related login prompt 1014 also suggests the selected sport, such as the football field graphic shown. The login prompt 1014 provides blank fields for the subscriber to enter their user id and password and a “Go” button to initiate subscriber verification.

Search

FIG. 10C illustrates a sport-specific search page. The search page follows successful verification of the subscriber information entered at the login prompt 1014 (FIG. 10B). The search page has a search page graphic set 1010 that includes the public-access buttons 1004 along the left-side of the page, a set of search mode buttons 1015 along the top of the page, the identifying logo 1006 at the top-left comer of the page, and a sport-specific identifier 1016 (e.g. football) also at the top-left comer of the page. In the center of the page is a sport-specific graphic 1018, such as the word “football” and an associated picture of football players, as shown. The search mode buttons 1015 allow the subscriber to select a specific search mode, including a player search, a position search, a regional search and a player profiler, as described above with respect to FIGS. 3A-D, respectively. The subscriber can also search for athlete information based on the player bookmark feature, described below with respect to FIG. 10J.

FIG. 10D illustrates a player search page. The player search page is presented to the subscriber as the result of their clicking the player search button 1015 (FIG. 10C) on the sport-specific search page (FIG. 10C). This page has the search page graphic set 1010 described above with respect to FIG. 10C. Player search prompts 1022 are located in the center of the page. The player search prompts 1022 have blanks for the subscriber to fill in information regarding the name, region and school of one or more athletes of interest. When the subscriber supplied information is complete, the subscriber initiates a search based on these parameters by clicking the search button 1024. The search proceeds as described with respect to FIG. 3A, above.

FIG. 10E illustrates a search results page. This page is presented to the subscriber in response to any subscriber initiated search requests, such as the player search described above with respect to FIG. 10D. The search results page has the search page graphic set 1010 described above. Search result records 1026 are displayed in the center of the page. Each of these records 1026 relate to a specific athlete contained in the athlete database 150 (FIG. 1). The athlete information present includes first and last name, school, city and state. The subscriber can select one of these records 1026 to retrieve athlete pages (FIGS. 10K-P) contained detailed information regarding a specific athlete. Alternatively, the subscriber can click the new search button 1028 to enter new search parameters.

FIG. 10F illustrates a position search page. The position search page is presented to the subscriber as the result of their clicking the associated player search button 1015 (FIG. 10C) on the sport-specific search page (FIG. 10C). The position search page has the search page graphic set 1010 described above with respect to FIG. 10C. A sport-specific playing field graphic 1032 is located at the center of the page. The playing field graphic 1032 incorporates selectable graphics that represent player positions on the playing field. A subscriber can initiate a search for athletes playing a certain position by clicking on one of these selectable position graphics, as described above with respect to FIG. 3B.

FIG. 10G illustrates a regional search page. The regional search page is presented to the subscriber as the result of their clicking the associated player search button 1015 (FIG. 10C) on the sport-specific search page (FIG. 1C). The regional search page has the search page graphic set 1010 described above with respect to FIG. 10C. A selectable regional list 1034 is located beneath the graphic set 1010. Also, a map 1036 is located beneath the regional list. A subscriber can initiate a search for athletes playing within a certain geographical region by selecting one or more regions from the regional list 1034 and also by selecting particular regions from the map 1036, as described above with respect to FIG. 3C. After the subscriber specifies the desired regions, they initiate a search by clicking the search button 1038.

FIG. 10H illustrates a player profiler page. The player profiler page is presented to the subscriber as the result of their clicking the associated player profiler button 1015 (FIG. 10C) on the sport-specific search page (FIG. 10C). The player profiler page has the search page graphic set 1010 described above with respect to FIG. 10C. A list of selectable, sport-specific player positions 1040 are located in the center of the page. In football, for example, the list of positions 1040 include a list of offense 1042, defense 1044 and special team 1046 positions. After the subscriber specifies the desired position 1040, they click the details button 1041, which initiates downloading of the position-specific parameters page (FIG. 10I).

FIG. 10I illustrates the position-specific parameters page, which is presented to the subscriber as the result of their selecting a particular position 1040 (FIG. 10H) within the player profiler page (FIG. 10H). The player profiler page has the search page graphic set 1010 described above with respect to FIG. 10C. A list of position specific parameter prompts 1048 are located in the center of the page. These prompts 1048 provide a blank space where the subscriber can enter a minimum player parameter (e.g., pass completions for a quarterback) or a maximum player parameter (e.g. interceptions).

The subscriber can click the select positions button 1049 to return to the player profiler page (FIG. 10H). The entered parameters are used to periodically search for athletes meeting the desired criteria, as described above with respect to FIG. 3D.

FIG. 10J illustrates the player bookmark page. The player bookmark feature allows the subscriber to save and quickly recall basic identifying information pertaining to a previously located athlete. All bookmarked players are displayed as records on the player bookmark page. Detailed information regarding a particular bookmarked athlete is retrieved when the subscriber clicks on the athlete's displayed record. The player bookmark page has the search page graphic set 1010 described above with respect to FIG. 10C. The records 1052 of previously bookmarked athletes are displayed in the center of the bookmark page. These records 1052 list the athletes first and last name, position, school, city, state and remarks. A delete button 1054 appears next to each record. The subscriber, by clicking a delete button 1054 eliminates a particular athlete from the bookmarked records 1052. An athlete is added to the bookmarked records 1052 by clicking the bookmark button 1058 (FIG. 10K) on an athlete information page (FIG. 10K-P).

### Athlete Data

FIGS. 10K-P illustrate athlete information pages that display biographical and statistical data in addition to tangible and intangible attributes regarding a particular athlete. As shown in FIG. 10K, for example, each page has a tabular graphic 1060, with selectable data tabs including physical attributes 1062, statistics 1063, personal 1064, coach's comments 1066, academics 1067 and game videos 1068. A page displaying athlete data corresponding to a particular one of these categories is downloaded when the subscriber clicks on the corresponding tab 1060. Also shown in FIG. 10K, for example, each athlete page has an athlete identifier block 1070 located along the top of the page. The identifier block 1070 contains an athlete picture 1072 and basic biographical information including name and birthdate 1074 and school, city and state 1076. Along the top-right comer of each page is the portal logo 1006 and the bookmark button 1058, described above with respect to FIG.

FIG. 10K illustrates the physical attributes page. This page is displayed when the subscriber selects the physical attributes tab 1062, which is shown in the foreground of the tabular graphic 1060 for reference. Physical attributes 1082 for a particular athlete are listed in the center of the page. These include, for example, body composition and the results of speed and strength tests.

FIG. 10L illustrates the statistics page. This page is displayed when the subscriber selects the statistics tab 1063, which is shown in the foreground of the tabular graphic 1060 for reference. Statistics 1083 for a particular athlete are listed in the center of the page. These are sport and position specific and include, for example, pass attempts and completions for a football quarterback.

FIG.10M illustrates the personal page. This page is displayed when the subscriber selects the personal tab 1064, which is shown in the foreground of the tabular graphic 1060 for reference. Personal data 1084 for a particular athlete are listed in the center of the page. These include, for example, comments regarding hobbies, family history, tournament participation and personal achievements.

FIG. 10N illustrates the coach's comments page. This page is displayed when the subscriber selects the coach's comments tab 1067, which is shown in the foreground of the tabular graphic 1060 for reference. Coach's comments 1086 for a particular athlete are listed in the center of the page. These include, for example, ratings from poor to excellent regarding leadership, work ethics and competitiveness and general comments from the player's coach.

FIG. 10O illustrates the academics page. This page is displayed when the subscriber selects the academics tab 1067, which is shown in the foreground of the tabular graphic 1060 for reference. Academics information 1088 for a particular athlete is listed in the center of the page. This information includes, for example, national test scores, GPA, grade level and comments regarding academic awards and extracurricular activities.

FIG. 10P illustrates the game videos page. This page is displayed when the subscriber selects the game videos tab 1068, which is shown in the foreground of the tabular graphic 1060 for reference. Available game videos and corresponding video links 1089 for a particular athlete are listed in the center of the page. Clicking on one of the video links initiates the multimedia player (FIG. 10Q) and the streaming download and playback of the associated multimedia segment.

### Multimedia Player

FIG. 10Q illustrates the multimedia player page, which is initiated when a video link is selected on the game video page (FIG. 10P). This page includes a multimedia player graphic 1090 having a display screen 1091 that simulates a TV screen and control buttons 1092 that simulate a standard VCR, including play, stop, pause, rewind and forward controls. The subscriber can control video playback on the screen 1091 by clicking any of these buttons 1092, which have the standard and well-known effect as labeled on the buttons. The multimedia player page also has an athlete picture 1072 and basic identifying information 1093 corresponding to the athlete featured in the displayed video. A team roster link 1094 is also provided, which initiates the roster page (FIG. 10R).

FIG. 10R illustrates the team roster page. The subscriber initiates this page by clicking on the team roster link 1094 (FIG. 10Q) located on any of the athlete pages (FIGS. 10K-P) or on the multimedia player page (FIG. 10Q). A selectable team tab graphic 1098 is located at the top of the page. Selecting a particular tab 1098 displays an associated player roster 1095 in the center of the page, including player names, jersey numbers and positions.

The multimedia sports recruiting portal has been disclosed in detail in connection with various embodiments of the present invention. These embodiments are disclosed by way of examples only and are not to limit the scope of the present invention, which is defined by the claims that follow. One of ordinary skill in the art will appreciate many variations and modifications within the scope of this invention.

What is claimed is:

1. A sports recruiting method allowing a subscriber to research and evaluate prospective athletes in order to recruit talent for a sports team, said method comprising the steps of:
compiling an athlete database containing the biographies, statistics and attributes of a plurality of athletes;
compiling a sports video database containing a plurality of video clips each featuring said athletes;
obtaining search criteria from said subscriber;
retrieving a portion of said athlete database and a portion of said sports video database regarding at least one of said athletes based upon said criteria;
displaying for said subscriber said athlete database portion; and
playing for said subscriber said sports video database portion.

2. The sports recruiting method of claim 1 wherein said compiling a sports video database step comprises the substeps of:
recording videos of sporting events and athletic performance tests;
transporting videos to an encoding facility;
capturing, editing and encoding videos at said facility to generate said video clips;
uploading said video clips to a data center;
archiving said video clips into said video database; and
associating each of said video clips to said athlete database.

3. The sports recruiting method of claim 1 wherein said obtaining step comprises the substeps of:
prompting said subscriber for a name;
reading said name as entered by said subscriber;
searching an index for a subset of said athletes each having said name;
displaying said subset to said subscriber; and
determining at least one of said athletes as selected by said subscriber from said subset.

4. The sports recruiting method of claim 1 wherein said obtaining step comprises the substeps of:
displaying a graphic to said subscriber depicting a plurality of player positions;
determining a particular one of said positions as selected by said subscriber;
displaying a graphic to said subscriber depicting a geographical map;
determining a particular region of said map as selected by said subscriber;
searching an index for a subset of said athletes corresponding to said particular position and said particular region;
displaying said subset to said subscriber; and
determining at least one of said athletes as selected by said subscriber from said subset.

5. The sports recruiting method of claim 1 wherein said obtaining step comprises the substeps of:
displaying a position specific statistic to said subscriber;
determining a range for said statistic as entered by said subscriber;
searching an index for a subset of said athletes each having performance falling within said range;
displaying said subset to said subscriber; and
determining at least one of said athletes as selected by said subscriber from said subset.

6. The sports recruiting method of claim 1 wherein said obtaining step comprises the substeps of:
retrieving a list of said athletes that said subscriber previously bookmarked for later review;
displaying said list to said subscriber; and
determining at least one of said athletes as selected by said subscriber from said list.

7. The sports recruiting method of claim 1 wherein said displaying step comprises the substeps of:
selectively listing physical attribute information at least one of said athletes including body composition, strength and performance test results; and
providing a link to particular ones of said video clips showing performance tests by at least one of said athletes.

8. The sports recruiting method of claim 1 wherein said displaying step comprises the substep of selectively listing game statistics regarding at least one of said athletes.

9. The sports recruiting method of claim 1 wherein said displaying step comprises the substep of selectively listing personal information of at least one of said athletes including awards and hobbies.

10. The sports recruiting method of claim 1 wherein said displaying step comprises the substep of selectively listing coach's comments regarding at least one of said athletes including ratings of leadership skills and competitiveness.

11. The sports recruiting method of claim 1 wherein said displaying step comprises the substep of selectively listing academic information regarding at least one of said athletes including grades, test scores and extracurricular activities.

12. The sports recruiting method of claim 1 wherein said displaying step comprises the substeps of:
selectively listing games participated in by said at least one of said athletes including the date and opponent; and
providing a link to particular ones of said video clips featuring game participation by at least one of said athletes.

13. A multimedia sports recruiting portal comprising:
a remote browser;
a central server in communications with said browser;
an athlete database having text data relating to a plurality of athletes, said athlete database accessible by said server;
a sports video database having multimedia clips relating to at least a portion of said athletes, said sports video database accessible by said server;
a link between said athlete database and said sports video database; and
a GUI downloaded from said server to said browser and displayed to a subscriber, said GUI prompting said subscriber for information used to query said athlete database.

14. The sports recruiting portal of claim 13 wherein said GUI is a player search page prompting said subscriber for an athlete name, a region and a school name.

15. The sports recruiting portal of claim 13 wherein said GUI is a sport graphic page prompting said subscriber to select a player position.

16. The sports recruiting portal of claim 13 wherein said GUI is a regional search page prompting said subscriber to select a geographical region.

17. The sports recruiting portal of claim 13 wherein said GUI is a player profiler prompting said subscriber to enter a required range for at least one performance statistic.

18. The sports recruiting portal of claim 13 wherein said GUI is a list of identifying records for athletes said subscriber previously bookmarked for later review.

19. A multimedia sports recruiting portal comprising:
a text database means for organizing and storing a plurality of records regarding athletes;
a video database means for organizing and storing a plurality of video clips featuring athletes in sporting events and performance tests;
a server means for accessing said text database means and said video database means and communicating with a remote client over a computer network; and
a GUI means for organizing and displaying selected portions of said records and said video clips at said client.

20. The multimedia sports recruiting portal of claim 19 further comprising an encoding center means for receiving, editing and uploading to said server means various video recordings.
